(19) United States
(12) Patent Application Publication
(10) Pub. No.: US 2026/0284540 A1
(43) Pub. Date: Sep. 24, 2026

(54) ENHANCEMENT EFFECT IN AUTO CHESS GAME

(71) Applicant: TENCENT TECHNOLOGY (SHENZHEN) COMPANY LIMITED, Shenzhen (CN)

(72) Inventors: Qiankun LIANG, Shenzhen (CN); Zhu MAO, Shenzhen (CN); Wei HUANG, Shenzhen (CN); Shuyun ZHANG, Shenzhen (CN); Yuxuan SHI, Shenzhen (CN); Zhengyang FANG, Shenzhen (CN)

(73) Assignee: TENCENT TECHNOLOGY (SHENZHEN) COMPANY LIMITED, Shenzhen (CN)

(21) Appl. No.: 19/688,377

(22) Filed: May 26, 2026

Related U.S. Application Data
(63) Continuation of application No. PCT/CN2025/074143, filed on Jan. 23, 2025.

(30) Foreign Application Priority Data
Feb. 8, 2024 (CN) 202410178238.7

(51) Int. Cl. A63F 13/822; A63F 13/533

(52) U.S. Cl. CPC A63F 13/822; A63F 13/533

(57) ABSTRACT

In a method for activating an enhancement effect in an auto chess game, i-th-round enhancement notification information is displayed, the i-th-round enhancement notification information indicating an i-th-round basic enhancement effect to be applied during the auto chess game, i being a positive integer. One or more i-th-round enhancement effects are applied during the auto chess game when (i+1)-th-round enhancement notification information is displayed, the one or more i-th-round enhancement effects including the i-th-round basic enhancement effect. One of the applied one or more i-th-round enhancement effects is activated for a virtual character when the virtual character meets an activation condition of the one of the one or more i-th-round enhancement effects, the virtual character corresponding to a target virtual player or a target virtual piece in the auto chess game.

### RELATED APPLICATIONS

The present application is a continuation of International Application No. PCT/CN2025/074143, filed on Jan. 23, 2025, which claims priority to Chinese Patent Application No. 202410178238.7, entitled “METHOD AND APPARATUS FOR ACTIVATING ENHANCEMENT EFFECT IN AUTO CHESS, TERMINAL, AND STORAGE MEDIUM” and filed on Feb. 8, 2024. The entire disclosures of the prior applications are hereby incorporated by reference.

### FIELD OF THE TECHNOLOGY

Embodiments of this disclosure relate to the technical field of human-computer interaction, including methods and apparatuses for activating an enhancement effect in an auto chess game, a terminal, and a storage medium.

### BACKGROUND

During an auto chess game, virtual players engaged in the match deploy their owned virtual pieces on a virtual board and control these virtual pieces to compete, thereby generating game results.

In a related technology, at a specific time point, such as a turn point or a game player level-up point, during the auto chess game, several enhancement effect options are randomly displayed for the game player to choose from, and then the selected enhancement effect is activated for the virtual player or virtual piece controlled by the game player. Thus, gaming modes are enriched.

However, because the selected enhancement effect is activated only for the virtual player or virtual piece controlled by the game player, and there are significant strength differences between different enhancement effects, this creates a large disparity between virtual players, thereby affecting the fairness during the auto chess game.

### SUMMARY

Embodiments of this disclosure include methods and apparatuses for activating an enhancement effect in an auto chess game, a terminal, and a storage medium.

In an aspect, an embodiment of this disclosure includes a method for activating an enhancement effect in an auto chess game. In the method, i-th-round enhancement notification information is displayed, the i-th-round enhancement notification information indicating an i-th-round basic enhancement effect to be applied during the auto chess game, i being a positive integer. One or more i-th-round enhancement effects are applied during the auto chess game when (i+1)-th-round enhancement notification information is displayed, the one or more i-th-round enhancement effects including the i-th-round basic enhancement effect. One of the applied one or more i-th-round enhancement effects is activated for a virtual character when the virtual character meets an activation condition of the one of the one or more i-th-round enhancement effects, the virtual character corresponding to a target virtual player or a target virtual piece in the auto chess game.

In an aspect, an embodiment of this disclosure includes an apparatus for activating an enhancement effect in an auto chess game. The apparatus includes processing circuitry configured to display i-th-round enhancement notification information, the i-th-round enhancement notification information indicating an i-th-round basic enhancement effect to be applied during the auto chess game, i being a positive integer. The processing circuitry is configured to apply one or more i-th-round enhancement effects during the auto chess game when (i+1)-th-round enhancement notification information is displayed, the one or more i-th-round enhancement effects including the i-th-round basic enhancement effect. The processing circuitry is configured to activate one of the applied one or more i-th-round enhancement effects for a virtual character when the virtual character meets an activation condition of the one of the one or more i-th-round enhancement effects, the virtual character corresponding to a target virtual player or a target virtual piece in the auto chess game.

In an aspect, an embodiment of this disclosure includes a non-transitory computer-readable storage medium storing instructions, which when executed by a processor, cause the processor to perform a method for activating an enhancement effect in an auto chess game. In the method, i-th-round enhancement notification information is displayed, the i-th-round enhancement notification information indicating an i-th-round basic enhancement effect to be applied during the auto chess game, i being a positive integer. One or more i-th-round enhancement effects are applied during the auto chess game when (i+1)-th-round enhancement notification information is displayed, the one or more i-th-round enhancement effects including the i-th-round basic enhancement effect. One of the applied one or more i-th-round enhancement effects is activated for a virtual character when the virtual character meets an activation condition of the one of the one or more i-th-round enhancement effects, the virtual character corresponding to a target virtual player or a target virtual piece in the auto chess game.

In an aspect, an embodiment of this disclosure includes a method for activating an enhancement effect in an auto chess game, the method being performed by a terminal and including: displaying i-th-round enhancement notification information, the i-th-round enhancement notification information indicating an i-th-round basic enhancement effect applied during an auto chess game when an (i+1)-th-round enhancement notification information is displayed, and i being greater than or equal to 1 and being a positive integer; applying an i-th-round enhancement effect during the auto chess game when (i+1)-th-round enhancement notification information is displayed, the i-th-round enhancement effect including the i-th-round basic enhancement effect; and activating the i-th-round enhancement effect for a virtual character in a case that the virtual character meets an activation condition for the i-th-round enhancement effect, the virtual character including at least one of a virtual player or a virtual piece in the auto chess game.

In another aspect, an embodiment of this disclosure includes an apparatus for activating an enhancement effect in an auto chess game, the apparatus including: a first information display module configured to display i-th-round enhancement notification information, the i-th-round enhancement notification information indicating an i-th-round basic enhancement effect applied during an auto chess game when an (i+1)-th-round enhancement notification information is displayed, and i being greater than or equal to 1 and being a positive integer; an effect application module configured to apply an i-th-round enhancement effect during the auto chess game when (i+1)-th-round enhancement notification information is displayed, the i-th-round enhancement effect including the i-th-round basic enhancement effect; and a first effect activation module configured to activate the i-th-round enhancement effect for a virtual character in a case that the virtual character meets an activation condition for the i-th-round enhancement effect, the virtual character including at least one of a virtual player or a virtual piece in the auto chess game.

In another aspect, an embodiment of this disclosure includes a terminal, including processing circuitry (e.g., a processor) and a memory (e.g., including a non-transitory computer-readable storage medium), the memory having at least one program stored therein, and the at least one program being loaded and executed by the processor to implement the method for activating an enhancement effect in an auto chess game based on one or more aspects in this disclosure.

In another aspect, an embodiment of this disclosure includes a non-transitory computer-readable storage medium, having at least one program stored therein, the at least one program being loaded and executed by processing circuitry (e.g., a processor) to implement the method for activating an enhancement effect in an auto chess game based on one or more aspects in this disclosure.

In another aspect, an embodiment of this disclosure includes a computer program product, including computer instructions stored in a non-transitory computer-readable storage medium. Processing circuitry (e.g., a processor) of a terminal reads the computer instructions from the non-transitory computer-readable storage medium, and executes the computer instructions to cause the terminal to perform the method for activating an enhancement effect in an auto chess game based on one or more aspects in this disclosure.

In one or more embodiments of this disclosure, during the auto chess game, the i-th-round enhancement notification information is displayed, and a notification is provided in advance on the i-th-round basic enhancement effect applied during the auto chess game when the (i+1)-th-round enhancement notification information is displayed. Thus, the i-th-round enhancement effect is applied during the auto chess game when the (i+1)-th-round enhancement notification information is displayed. Besides, the i-th-round enhancement effect is activated for the virtual character in a case that the virtual character meets the activation condition for the i-th-round enhancement effect. To be specific, a notification will be provided in advance for the enhancement effect applied in each round when the enhancement notification of the previous round is provided. Thus, between the i-th-round enhancement notification information and the (i+1)-th-round enhancement notification information, a game player can properly adjust a battle strategy based on the i-th-round enhancement notification information, thereby improving the strategic depth of the auto chess game. Moreover, as long as a virtual character meets an activation condition for an enhancement effect, the enhancement effect can be applied to the virtual character. Thus, the fairness of enhancement effect activation during the auto chess game is enhanced.

Furthermore, by providing a multi-round enhancement notification mechanism for the auto chess game, enhancement effects can be orderly applied based on the notification rounds during the auto chess game. Thus, activation condition determination may be performed on the enhancement effect applied in a single notification round, and may not be performed in real time on various enhancement effects. Accordingly, the determination pressure of effect activation conditions is lowered, and the computing resource losses are reduced.

### BRIEF DESCRIPTION OF THE DRAWINGS

FIG. 1 is a structural block diagram of a computer system according to an embodiment of this disclosure.

FIG. 2 is a flowchart of a battle interaction method for a turn-based board game according to an embodiment of this disclosure.

FIG. 3 is a schematic diagram of a battle interface of a turn-based board game according to an embodiment of this disclosure.

FIG. 4 is a schematic diagram of a piece card according to an embodiment of this disclosure.

FIG. 5 is a schematic diagram of an effect card according to an embodiment of this disclosure.

FIG. 6 is a schematic diagram of an equipment card according to an embodiment of this disclosure.

FIG. 7 is a schematic diagram of a player card according to an embodiment of this disclosure.

FIG. 8 is a flowchart of a battle interaction method for a turn-based board game according to an embodiment of this disclosure.

FIG. 9 is a schematic diagram of a player selection interface according to an embodiment of this disclosure.

FIG. 10 is a schematic diagram of a battle interface during a preparation phase according to an embodiment of this disclosure.

FIG. 11 is a schematic diagram of an interface when a card is played during a preparation phase according to an embodiment of this disclosure.

FIG. 12 is a schematic diagram of a level-up process of a level-up button according to an embodiment of this disclosure.

FIG. 13 is a schematic diagram of a level-up process of a level-up button according to an embodiment of this disclosure.

FIG. 14 is a schematic diagram of a battle interface during a battle phase according to an embodiment of this disclosure.

FIG. 15 is a schematic diagram of a settlement interface according to an embodiment of this disclosure.

FIG. 16 is a flowchart of a method for activating an enhancement effect in an auto chess according to an embodiment of this disclosure.

FIG. 17 is a schematic diagram of an interface when an i-th-round enhancement notification information is displayed according to an embodiment of this disclosure.

FIG. 18 is a flowchart of a method for activating an enhancement effect in an auto chess provided by another embodiment of this disclosure.

FIG. 19 is a schematic diagram of an interface showing that a first-round enhancement notification information is displayed when a battle is started according to an embodiment of this disclosure.

FIG. 20 is a schematic diagram of an interface showing that first-round enhancement notification information is displayed while a second-round enhancement notification information is displayed according to an embodiment of this disclosure.

FIG. 21 is a schematic diagram of an interface showing that first-round enhancement notification information is updated from an implicit notification state to an explicit notification state according to an embodiment of this disclosure.

FIG. 22 is a schematic diagram of an interface showing that an i-th-round additional enhancement effect is displayed according to an embodiment of this disclosure.

FIG. 23 is a schematic diagram of an interface showing that a virtual player triggers an additional enhancement effect according to an embodiment of this disclosure.

FIG. 24 is a schematic diagram of an interface showing that no virtual player triggers an (i+1)-th-round enhancement notification for an i-th-round additional enhancement effect according to an embodiment of this disclosure.

FIG. 25 is a schematic diagram of an interface showing that a virtual piece in a second piece state casts a skill according to an embodiment of this disclosure.

FIG. 26 is a schematic diagram of an interface showing that virtual pieces of the same type in a second piece state jointly cast skills according to an embodiment of this disclosure.

FIG. 27 is a schematic diagram of an interface showing that an additional enhancement effect is activated for a virtual piece in an auto chess game according to an embodiment of this disclosure.

FIG. 28 is a schematic diagram of a display effect application progress presentation interface according to an embodiment of this disclosure.

FIG. 29 is a schematic diagram of an effect application progress presentation interface when there is an additional enhancement effect according to an embodiment of this disclosure.

FIG. 30 is a flowchart of a method for activating an enhancement effect in an auto chess according to yet another embodiment of this disclosure.

FIG. 31 is a structural block diagram of an apparatus for activating an enhancement effect in an auto chess according to an embodiment of this disclosure.

FIG. 32 is a structural block diagram of a terminal according to an embodiment of this disclosure.

### DETAILED DESCRIPTION

To describe the objectives, technical solutions, and advantages of this disclosure, one or more embodiments of this disclosure will be described in further detail with reference to the accompanying drawings.

Descriptions of terms in this disclosure are provided as examples and are not intended to limit the scope of the disclosure.

Turn-Based Board Game: A turn-based board game may refer to a board game in which pieces (virtual pieces) are pre-arranged before the battle (or also referred to as a match or a game), and during the battle, the pieces automatically engage in combat (or also referred to as competition) according to the pre-arrangement. The “pieces” are typically represented by virtual characters, which may be referred to, for example, as virtual heroes. During the game, the virtual characters automatically cast various skills to battle. The battle is typically turn-based. When all pieces on one side are defeated (i.e., the health points of the virtual character are reduced to zero), this side may be considered the losing side of the current turn. In some embodiments, in addition to the “piece type virtual characters” used for a battle, each of the two opposing sides is further provided with a player character representing the current user participating in the battle. The player character is prevented from being moved to the battle area or the piece candidate area as a “piece”. The player character is also assigned health points (or hit points). The health points of the player character are correspondingly reduced (in case of a battle loss) or remain unchanged (in case of a battle win) based on the outcome of each battle. When the health points of this virtual character are reduced to zero, the user corresponding to the player character withdraws from the battle, and the remaining users continue the battle. In one embodiment, the turn-based board game includes auto chess.

Auto Chess: Auto chess may refer to a turn-based competitive multiplayer game with in-game trading of hero pieces. For example, the game involves eight or six game players, each occupying a designated area on the board. Two game players among a plurality of game players engage in a one-on-one battle or match. Each turn of a battle includes two phases: a preparation phase and a battle (or match) phase. During the preparation phase, the users purchase pieces (heroes) from a shop and arrange lineups on the board. During the battle phase, the lineups of both sides are locked, and the pieces automatically engage in combat until all pieces on one side are defeated. The side whose pieces are all defeated may be considered the losing side of the turn and will have a particular number of hit points deducted. The game turns repeat continuously, matching players with new opponents, until a game player is eliminated when the game player's health points are ≤0. The last remaining game player wins the game (achieves 1ₛₜ place).

Board: A board may refer to an area within the battle interface (or a match interface) of a turn-based board game used for preparing for and conducting battles. The board may be a two-dimensional virtual board, a 2.5-dimensional virtual board, or a three-dimensional virtual board. This is not limited in this disclosure.

The board for an auto chess in some examples may be divided into a battle area and a piece candidate area. The battle area includes a plurality of grid cells of the same size for holding pieces that engage in combat during the battle. The piece candidate area includes a plurality of candidate piece positions for holding candidate pieces that do not participate in combat during the battle and can be dragged and placed into the battle area during the preparation phase. The board area provided in one or more embodiments of this disclosure excludes the piece candidate area but includes only the battle area.

Regarding the arrangement of grid cells in the battle area, in some embodiments, the battle area includes n (rows)×m (columns) grid cells. For example, n is an integer multiple of 2, and two adjacent rows of grid cells are aligned, or two adjacent rows of grid cells are staggered. Furthermore, the battle area is equally divided into two parts by rows, namely a current player's battle area and an opposing player's battle area. Users participating in battle are respectively located on the upper and lower sides of the battle interface, and during the preparation phase, a user may place pieces in the current player's battle area. In some other embodiments, the battle area is equally divided into two parts by columns, namely a current player's battle area and an opposing player's battle area, and users participating in battle are respectively located on the left and right sides or the upper and lower sides of the battle interface. The shape of the grid cell may be any one of square, rectangle, circle, or hexagon. The shape of the grid cell is not limited in this disclosure.

Card: Cards or a card may correspond to a common term for a type of game, originating from tabletop games. Unlike directly manipulating piece models when playing chess, a card carries the game's content on it. Compared to pieces, cards may be more convenient for conveying textual descriptions, card attribute information, and some key numerical values. “Cardification” may refer to representing hero resources as card resources, thereby facilitating game players in reading and categorizing card effects, and conveying information across more dimensions.

Energy: Energy may correspond to a form of resources in games. In this disclosure, energy is defined as a resource used by the game player to play cards. Playing a particular card requires consuming the corresponding amount of energy indicated on the card.

Equipment: In auto chess games, each piece may wear 3 (or other numbers) pieces of equipment. Equipment may provide attributes or effects to the hero, such as attack, defense, health points, healing, penetration, and shield. Auto chess games in the related technology typically include a neutral creep round. Game players obtain equipment dropped by defeating neutral creeps and pick up the equipment into backpacks. Equipment may alternatively be synthesized from basic components to obtain higher-quality equipment.

Player: A player in a game may correspond to a virtual character played by a game player. Each player possesses different special abilities that can assist the game player in playing the game more effectively.

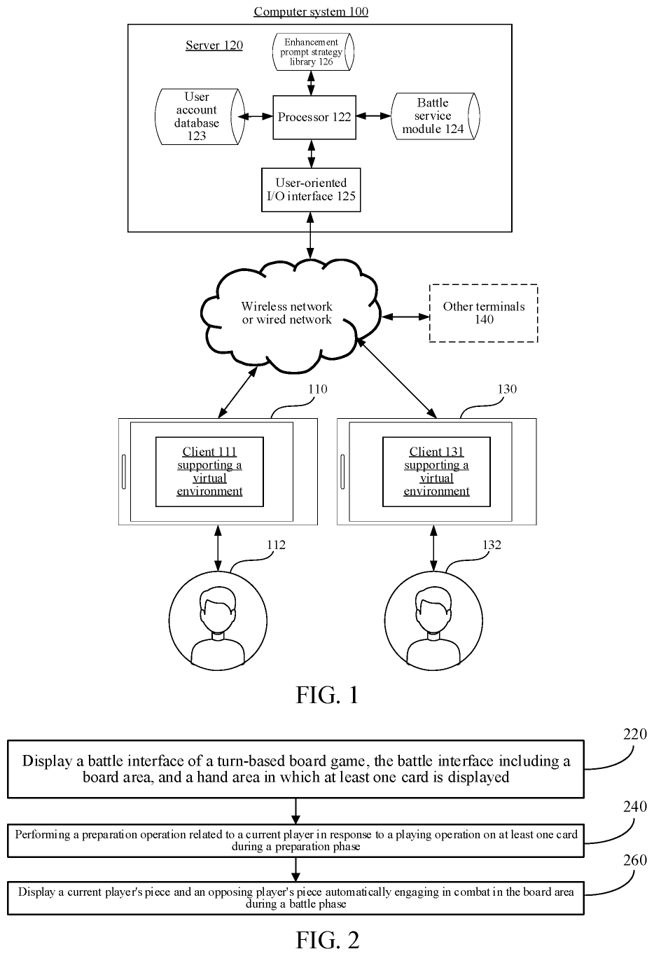

FIG. 1 illustrates a structural block diagram of a computer system provided by an embodiment of this disclosure. The computer system 100 includes a first terminal 110, a server 120, and a second terminal 130.

A client 111 supporting a virtual environment is installed and runs on the first terminal 110. The client 111 may be a program of a turn-based board game. When the first terminal runs the client 111, a user interface of the client 111 is displayed on the screen of the first terminal 110. The client may be a client of an auto chess game. The first terminal 110 is a terminal used by a first user 112. The first user 112 arranges pieces in the battle area of the board by using the first terminal 110 during the preparation phase of a battle. The first terminal 110 or the server 120 automatically controls the pieces to battle during the battle phase according to the attributes, skills, and the arrangement of the pieces in the battle area.

A client 131 supporting a virtual environment is installed and runs on the second terminal 130. The client 131 may be a program of a turn-based board game. When the second terminal 130 runs the client 131, a user interface of the client 131 is displayed on the screen of the second terminal 130. The client may be a client of an auto chess game. The second terminal 130 is a terminal used by a second user 132. The second user 132 arranges pieces in the battle area of the board by using the second terminal 130 during the preparation phase of a battle. The second terminal 130 or the server 120 automatically controls the pieces to battle during the battle phase according to the attributes, skills, and the arrangement of the pieces in the battle area.

In one embodiment, the pieces arranged by the first user via the first terminal 110 and those arranged by the second user via the second terminal 130 are located in different battle areas on the same board. To be specific, the first user and the second user are in the same board within the same battle. Alternatively, the pieces arranged by the first user via the first terminal 110 and those arranged by the second user via the second terminal 130 are located on different boards. In an embodiment, a single battle of the turn-based board game involves six user accounts. In each turn, the six user accounts are paired up, and the two user accounts that are paired together engage in a battle on the same board during this turn.

In one embodiment, the clients installed on the first terminal 110 and the second terminal 130 are the same, or the clients installed on the two terminals are the same type of clients on different operating system platforms (Android or IOS). The first terminal 110 may refer to one of a plurality of terminals, and the second terminal 130 may refer to another one of the plurality of terminals. This embodiment uses only the first terminal 110 and the second terminal 130 as an example for description. The first terminal 110 and the second terminal 130 are of the same or different device types, including at least one of a smartphone, a tablet computer, an e-book reader, a moving picture experts group audio layer III (MP3) player, a moving picture experts group audio layer IV (MP4) player, a laptop computer, or a desktop computer. In the following embodiment, an example in which a terminal includes a smartphone is used for description.

A person skilled in the art may understand that more or fewer terminals may be provided. For example, the above-mentioned terminal may be just one (i.e., the user battles against artificial intelligence) or may be 6 or 8 or more. The number of terminals and the device types are not limited in this disclosure.

Only two terminals are shown in FIG. 1. However, in different embodiments, there may be a plurality of other terminals 140 that can access the server 120. In one embodiment, there are alternatively one or more terminals 140 that correspond to a developer. A development and editing platform for a client that supports a virtual environment is installed on the terminal 140. The developer may edit and update the client on the terminal 140, and transmit an updated client installation package to the server 120 over a wired or wireless network. The first terminal 110 and the second terminal 130 may download the client installation package from the server 120 to update the client.

The first terminal 110, the second terminal 130, and the other terminals 140 are connected to the server 120 via a wireless network or a wired network.

The server 120 is implemented as at least one of one server, a plurality of servers, a cloud computing platform, or a virtualization center. The server 120 is configured to provide a background service for a client supporting a three-dimensional virtual environment (a client of a turn-based board game/a client of an auto chess game). In one embodiment, the server 120 undertakes main computing work, and the terminal undertakes secondary computing work. Alternatively, the server 120 undertakes the secondary computing work, and the terminal undertakes the main computing work. Alternatively, the server 120 and the terminal perform collaborative computing by using a distributed computing architecture.

In an embodiment, the server 120 includes a processor 122, a user account database 123, a battle service module 124, a user-oriented input/output (I/O) interface 125, and an enhancement notification strategy library 126. The processor 122 is configured to load instructions stored on the server 120, and process data in the user account database 123, the battle service module 124, and the enhancement notification strategy library 126. The user account database 123 is configured to store data of user accounts used by the first terminal 110, the second terminal 130, and the other terminals 140, such as avatars of the user accounts, nicknames of the user accounts, fighting power indexes of the user accounts, and service areas of the user accounts. The battle service module 124 is configured to provide a plurality of battle rooms for users to battle. The user-oriented I/O interface 125 is configured to establish communication with the first terminal 110 and/or the second terminal 130 via a wireless network or a wired network for data exchange. The enhancement notification strategy library 126 is configured to store a plurality of enhancement effects and enhancement effect combination strategies, such as enhancement effect combination strategies among a plurality of virtual players and virtual pieces participating in the same auto chess game.

An embodiment of this disclosure includes a turn-based board game (auto chess) operating based on cards. The various complex operations involved in traditional auto chess, such as store purchase, store leveling up, piece preparation, piece deployment, piece leveling up, and piece equipment, are all simplified within the playing process of cards. On the one hand, the playing process based on cards is relatively simple and well-suited for use on small-screen terminals such as mobile phones and tablets. On the other hand, the three-dimensional models of virtual pieces may carry limited textual information, whereas the face of a card can carry more information such as “label”, “value”, “attribute”, and “affix effect”, thereby improving the utilization efficiency of the display area where the card is located.

FIG. 2 illustrates a flowchart of a battle interaction method for a turn-based board game provided by an embodiment of this disclosure. In an embodiment, an example in which the method is performed by a terminal is used for description. A client supporting the turn-based board game runs on the terminal. The method includes the following operations:

Operation 220: A battle interface of a turn-based board game is displayed, the battle interface including a board area, and a hand area in which at least one card is displayed.

The battle interface is an interface in which two game player objects engage in a turn-based battle in the turn-based board game. The game player object may be understood as at least one of the following concepts: a user, an account, a game player, a player, or a virtual player.

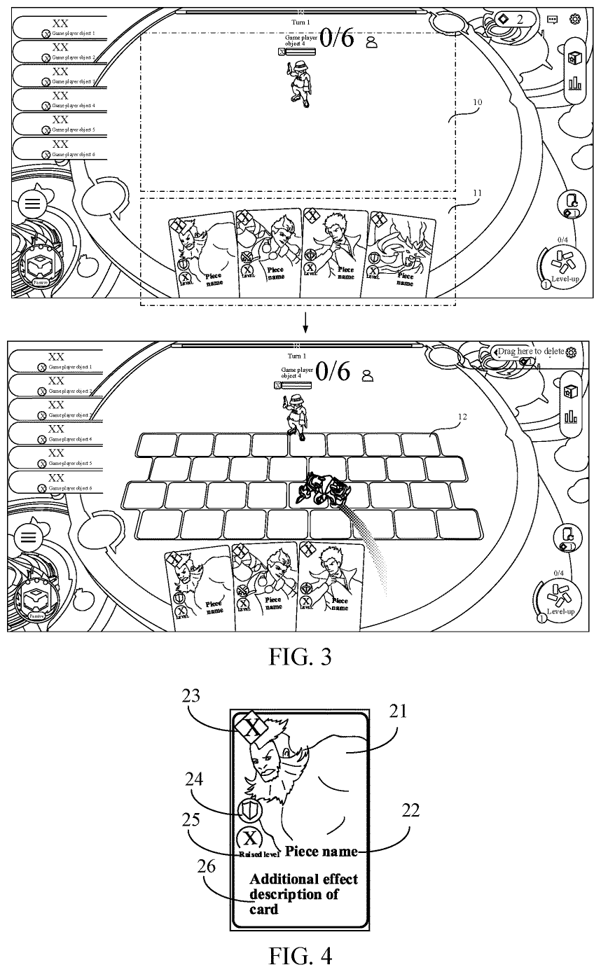

Referring to FIG. 3, the battle interface includes a board area 10 and a hand area 11.

The board area 10 is configured to accommodate at least one current player's piece and at least one opposing player's piece participating in the battle. The board area 10 includes a plurality of grid cells 12 arranged in an array, and these grid cells 12 are either always displayed or displayed only at particular times. In one embodiment, the board area 10 is a two-dimensional board or a three-dimensional board. In an embodiment, the board area 10 is illustrated as a three-dimensional board viewed from above. The three-dimensional board herein means that the board is located in a three-dimensional environment, rather than that the board itself is necessarily in a three-dimensional form.

The card area 11 is configured to display at least one card held by or dealt to the current game player object. The at least one card is typically a plurality of cards. The at least one card includes at least one of the following: cards automatically drawn or dealt to the current game player object by a background program, cards obtained after playing particular cards with a card-drawing effect, or player cards obtained because of a player skill. There is an upper limit for the number of the plurality of cards, for example, a maximum of 8 cards, with any excess cards being automatically discarded.

In one embodiment, the plurality of cards are arranged in a fan shape within the hand area 11. The arrangement order may be determined based on at least one factor such as the time of drawing, card type, the number of cards of the same type, the number of copies of the same card, or the quality level of the card. In one embodiment, there is an upper limit for the number of the at least one card held by the current game player object, for example, a maximum of 8 or 10 cards, with any cards exceeding the upper limit being discarded. The current game player object may play all or part of the cards in each turn. In one embodiment, in each turn, the current game player object may alternatively replace all or part of the cards. In one embodiment, different cards have different card types. Different card types have different preparation functions.

A single battle of the turn-based board game includes a plurality of turns. Each turn includes a preparation phase and a battle phase.

Operation 240: Perform a preparation operation related to the current player in response to a playing operation on at least one card during the preparation phase.

The playing operation refers to an operation of playing one or more cards held. For example, the playing operation is an operation of dragging a selected card toward the board area. Alternatively, the playing operation includes a first clicking/tapping operation and a second clicking/tapping operation. The first clicking/tapping operation is an operation of clicking/tapping to select a card, and the second clicking/tapping operation is an operation of clicking/tapping on a grid cell in the board area. The specific form of the playing operation is not limited in this disclosure. In some embodiments, a function of intelligently recommending cards to play may further be provided, which plays cards on behalf of the current game player object in particular turns. For example, in the first few turns for a novice game player, the client may intelligently recommend cards to play.

At least one current player's piece refers to a virtual piece that participates in the battle in at least one turn (including the current turn). When the board area is a two-dimensional board, the virtual piece is also a two-dimensional piece, displayed as a two-dimensional icon or a two-dimensional representation. When the board area is a three-dimensional board, the virtual piece is also a three-dimensional piece, displayed as a three-dimensional model or a three-dimensional representation. In an initial state, the number of current player's pieces located in the board area may be zero, and the current player's pieces may be added, removed, or replenished in the board area by the current game player object. The current player's pieces that survived the previous turn may be automatically carried over to the next turn.

The display state of a selected card is different from that of a non-selected card. In one embodiment, the selected card has a prominent display effect. The prominent display effect includes: a bold border, a highlighted border, a dynamic border, and moving the card's position in the card queue toward the board area by a preset distance.

The preparation operation includes at least one of the following: adding a current player's piece, removing a current player's piece, leveling up a current player's piece, equipping a current player's piece with equipment, removing equipment from a current player's piece, or adding a buff to a current player's piece.

Since different card types have different effects, the preparation operation is performed on at least one current player's piece in the board area based on the card type of the selected card.

During the preparation phase, the current game player object prepares at least one current player's piece in the board area, and an opposing game player object prepares at least one opposing player's piece in the board area.

Operation 260: Display that the current player's piece and the opposing player's piece automatically engage in combat in the board area during the battle phase.

The automatic combat process between the current player's piece and the opposing player's piece in the board area does not require manual control by the current game player object. Instead, the client or server automatically controls the combat between the pieces on both sides based on at least one factor such as the grid cell positions of the pieces on both sides on the board, piece attributes, piece levels, piece skills, piece attributes, and combined enhancement attributes between pieces, until all pieces on one side are defeated.

Both the current game player object and the opposing game player object have health points. After the current turn ends, the health points of the game player object on the losing side will be deducted by a particular amount. The particular amount may be determined based on the number of remaining pieces on the winning side, or may be a fixed value. This is not limited in this disclosure.

Accordingly, the method provided in an embodiment introduces a “card” mechanism into the turn-based board game, simplifying and integrating various preparation operations into the process of playing a plurality of cards. The concept of a store is eliminated, and the game player no longer needs to perform a plurality of interactions between sub-areas such as a store, a piece preparation area, and a piece battle area on a traditional battle interface to complete the acquisition, leveling up, and battling of pieces. The traditional process of purchasing pieces that required active selection by the user is replaced by passively receiving dealt cards, whereby the game system performs part of the tedious operations on behalf of the user. The user only needs to perform playing operations substantially similar to those in card games to complete various preparation operations. Thus, the human-computer interaction efficiency is improved.

In particular, when operating the turn-based board game on a small-screen terminal such as a mobile phone or a tablet, the game player can complete various preparation operations based on limited operations within the hand area. Compared to traditional auto chess, the human-computer interaction efficiency is improved.

### Classification of Card Types:

In some embodiments, the card types include at least one of: piece cards, effect cards, equipment cards, or player cards.

### Piece Card:

A piece card is a card configured to summon a current player's piece in the board area or to level up a current player's piece. FIG. 4 illustrates a schematic diagram of a piece card. The piece card displays at least one of the following information: a piece representation 21, a piece name 22, an energy value 23 consumed when playing the card, a piece type or faction 24 to which the piece belongs, a level 25 to which the piece is raised after playing the card, or an additional effect description 26 of the piece.

The piece representation 21 may be at least one of an avatar, an icon, a half-body portrait, a full-body portrait, or a presentation animation of the virtual piece. FIG. 4 illustrates an example in which the piece representation 21 is a half-body portrait of the virtual piece.

The piece name 22 is the name of the virtual piece. Taking as an example that the virtual piece is a hero, the piece name is a hero name.

The energy value 23 refers to the energy value to be consumed when playing the piece card, and the energy value is an integer. Energy is a type of resource in the turn-based board game. In one embodiment, cards of different qualities require different amounts of energy to be consumed when played. For example, cards of five different qualities require 0, 1, 2, 3, and 4 energy points, respectively, when played.

The piece type 24 is a classification attribute of a character played by a piece in a battle process. In an example, different pieces may be classified into at least one piece type of a tank, a warrior, an assassin, a mage, a marksman, and a support. A faction is a classification attribute that pieces belong to the same piece group in the virtual world view. In an example, different pieces may be divided into at least one of the factions: Great Wall, Third Parts, Xuanyong, Mech, Yaotian, and Chang'an. For example, in the virtual world view, 2 pieces serving as the guards for the Great Wall belong to the faction of the Great Wall. In different embodiments, the piece type and the faction may be considered as the same classification attribute. In an embodiment, an example in which the piece type and the faction are different classification attributes is used.

The level 25 to which the piece is raised after playing the card refers to the piece level to which an existing piece with the same name (i.e., the same piece) in the board area is raised after the card is played. For example, if the level 25 is level 3 and the piece with the same name was originally at level 2, the piece with the same name is raised to level 5 after the card is played. In one embodiment, the piece with the same name is raised to different levels after cards of different qualities are played. For example, the piece with the same name is raised to levels 1, 2, 3, 4, and 5 after cards of five different qualities are played, respectively.

The additional effect description 26 of a piece is an effect description of the additional effect possessed by the piece. The additional effect may take effect immediately when the card is played, or may take effect when a particular trigger condition is met during the battle process. For example, piece 1 has an exclusive skill: when the piece 1 is on the board, whenever another current player's piece in the board area is sold, a current player's piece on the board that has the piece type of “tank” is randomly selected, and the level of the randomly selected current player's piece on the board is raised by a first value, where the first value is half the level of the sold piece.

### Effect Card:

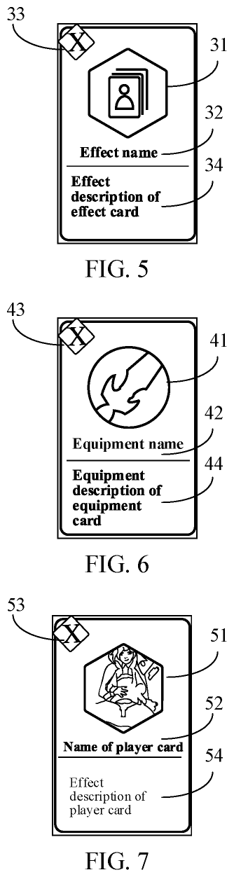

An effect card is a card configured to apply an effect to at least one game factor within a game battle, the at least one game factor including a piece, a skill, equipment, a buff, a level, a combat process, a hand acquisition process, or the like. FIG. 5 illustrates a schematic diagram of an effect card. The effect card displays at least one of the following information: an effect icon 31, an effect name 32, an energy value 33 consumed when playing the card, or an effect description 34 of the effect card.

The effect icon 31 may be an icon representing the buff of the effect card. FIG. 5 illustrates an example in which the icon has a hexagonal frame. The effect name 32 is the name of the effect card or the name of the buff.

The energy value 33 refers to the energy value to be consumed when playing the effect card, and the energy value is an integer. Energy is a type of resource in the turn-based board game. In one embodiment, cards of different qualities require different amounts of energy to be consumed when played. For example, cards of five different qualities require 0, 1, 2, 3, and 4 energy points, respectively, when played.

The effect description 34 of the effect card is configured to describe the effect of the effect card after being used. The effect of the effect card includes, but is not limited to, at least one of:
1, enhancing the probability of acquiring piece cards for the current player and/or increasing the number thereof;
2, enhancing the probability of acquiring piece cards with the same name as a piece on the board for the current player or increasing the number thereof;
3, reducing the energy required for the current player to acquire piece cards;
4, increasing the number of piece cards traded by the current player;
5, reducing the energy required for the current player to trade piece cards;
6, raising the level of at least one piece on the board;
7, adding equipment to at least one piece on the board;
8, leveling up the equipment for at least one piece on the board;
9, reducing energy consumption when playing/exchanging cards;
10, increasing the probability of acquiring particular cards;
11, increasing the number of particular cards acquired;
12, increasing the number of exchange opportunities, or other similar effects.

For example, the effect of a “Duo” card is to randomly obtain 2 identical hero cards. The effect of a “Talent Search” card is to choose 1 from 3 hero cards of the highest quality available at the current player level. The effect of a “Copy” card is to randomly obtain one card with the same name as a hero on the board. The effect of a “Bountiful Harvest” card is to immediately replenish the hand to 5 cards. The effect of a “Random Enhancement” card is to randomly raise the level of one hero on the board by 5. The effect of a “One More Time” card is to draw one card and gain one additional free exchange opportunity for the current turn. The effect of a “Wish” card is to reduce the energy value consumed by all cards by 1. The effect of an “Add Card” card is to draw 2 cards.

In some embodiments, effect cards may be classified into at least one of the following: general effect cards, piece type-specific effect cards, or faction-specific effect cards. A general effect card is an effect card of which the card attribute is not related to piece type or faction. The card attribute includes at least one of the following: acquisition condition, use condition, card effect, or action range. A piece type-specific effect card is an effect card of which the card attribute is related to piece type, for example, an effect card that may be acquired, used, or enjoyed by pieces of a specific piece type. A faction-specific effect card is an effect card of which the card attribute is related to faction, for example, an effect card that may be acquired, used, or enjoyed by pieces of a specific faction.

For example, a particular piece type-specific effect card may be obtained with a particular probability when a piece card of this piece type is played.

### Equipment Card:

An equipment card is a card configured to equip at least one current player's piece with equipment. FIG. 6 illustrates a schematic diagram of an equipment card provided by an embodiment of this disclosure. The equipment card displays at least one of the following information: an equipment icon 41, an equipment name 42, an energy value 43 consumed when playing the card, or an equipment description 44 of the equipment card.

The equipment icon 41 may be an icon configured for representing the appearance of equipment or the effect of equipment. FIG. 6 illustrates an example in which the icon has a circular frame. The equipment name 42 is the name of the equipment card or the name of the equipment. Different equipment can enhance the combat capability of current player's pieces in different dimensions such as hit points, armor, defense, and mana, or weaken the combat capability of opposing player's pieces.

The energy value 43 refers to the energy value to be consumed when playing the equipment card, and the energy value is an integer. Energy is a type of resource in the turn-based board game. In one embodiment, cards of different qualities require different amounts of energy to be consumed when played. For example, cards of five different qualities require 0, 1, 2, 3, and 4 energy points, respectively, when played. In one embodiment, the energy values consumed by different cards may alternatively be adjusted periodically or aperiodically based on game balance considerations.

The equipment description 44 of the equipment card is configured to describe the effect of the equipment after it is equipped.

### Player Card:

A player card is a card obtained via a player skill of a virtual player. The player card may be a card obtained by triggering a passive skill of the virtual player, a card that may be obtained by a particular virtual player, a card that may be used by a particular virtual player, a card exclusive to a particular virtual player, or the like. This is not limited in this disclosure.

FIG. 7 illustrates a schematic diagram of a player card provided by an embodiment of this disclosure. The player card displays at least one of the following information: a card icon 51, a player card name 52, an energy value 53 consumed when playing the card, or an equipment description 54 of the player card.

The card icon 51 may be an icon configured for representing a card effect. FIG. 7 illustrates an example in which the icon has a hexagonal frame. The player card name 52 is the name of the player card or the name of the effect.

The energy value 53 refers to the energy value to be consumed when playing the player card, and the energy value is an integer. Energy is a type of resource in the turn-based board game. In one embodiment, cards of different qualities require different amounts of energy to be consumed when played. For example, cards of five different qualities require 0, 1, 2, 3, and 4 energy points, respectively, when played. In one embodiment, the energy values consumed by different cards may alternatively be adjusted periodically or aperiodically based on game balance considerations.

The effect description 54 of the player card is configured to describe the effect that can be added after the player card is used. The effect of the player card may be the same as or similar to the effects of the piece card, the equipment card, and the effect card, and may alternatively go beyond the scope of the effects of the piece card, the equipment card, and the effect card. In possible designs of different embodiments, the effect of the player card may be designed as any form of effect, such as summoning a piece, leveling up a piece, adding equipment, adding a buff, reducing energy consumption, or affecting the hand acquisition process. The effect of the player card may be designed to affect any process or detail in the game battle. This is not limited in this disclosure.

Based on the introduction of the four types of cards described above:

On the one hand, different types of cards have different functions. With piece cards, the store in traditional auto chess can be eliminated based on the playstyle characteristics of the cards. With the effect cards, the effect buttons or controls in traditional auto chess can be eliminated. With the equipment cards, the neutral creep round in traditional auto chess can be eliminated. With the player cards, gameplay characteristics related to players can be integrated. By simplifying different mechanisms in the turn-based board game into the card playing process based on different types of cards, the number of user interface elements that need to be displayed on the battle interface can be reduced, and the operations for the current game player object can be further simplified, thereby improving the human-computer interaction efficiency for the current game player object.

On the other hand, compared with three-dimensional pieces, two-dimensional cards are inherently capable of carrying more textual information and icon information, whereas three-dimensional pieces may carry limited textual information. Thus, compared with three-dimensional pieces in traditional preparation phases, two-dimensional cards can increase the amount of information carried within the limited display area on small-screen terminals, thereby improving the information conveying efficiency.

The cards described above can be played during the preparation phase, and some cards can be played during the battle phase, such as particular equipment cards, and effect cards of immediately drawing 2 more cards.

A card is acquired as follows:

The current game player object acquires at least one card when an acquisition condition is met. The acquisition condition includes at least one of the following acquisition conditions:
Acquisition Condition 1: A new round of turn-based combat is started. Each time a new round of turn-based combat is started, a plurality of cards are obtained. For example, 4 cards are drawn in the first round of turn-based combat, and 2 cards are drawn in subsequent rounds of turn-based combat.
Acquisition Condition 2: A preset piece card is used. The preset piece card refers to a piece card that has an additional skill such as drawing, adding, or copying cards. For example, when a piece card with the same name as a piece on the board is played, an additional effect card is acquired.
Acquisition Condition 3: A preset effect card is used. The preset effect card refers to an effect card that has an action effect such as drawing, adding, or copying cards.
Acquisition Condition 4: A preset player card is used. The preset player card refers to an effect card that has an action effect such as drawing, adding, or copying cards.
Acquisition Condition 5: The resources possessed by the current player are consumed for trading. For example, energy is consumed to draw or trade cards.
Acquisition Condition 6: The level of the virtual player is raised. After the level is raised, access to cards of higher quality or a greater number of cards may be unlocked.
Acquisition Condition 7: The card pool is leveled up. After the card pool is leveled up, access to cards of higher quality or a greater number of cards may be unlocked.
Acquisition Condition 8: A card purchase operation is performed.
Acquisition Condition 9: A preset player skill is triggered. The preset player skill refers to a passive skill that has an action effect such as drawing, adding, or copying cards. For example, one player card may be drawn every two turns; or one player card may be drawn for every three cards played.

The above acquisition conditions may be in combination. For example, particular cards can be obtained by using a preset player card after the player level reaches level 2. Additionally, the acquisition conditions for different types of cards may be different, the same, or partially the same and partially different.

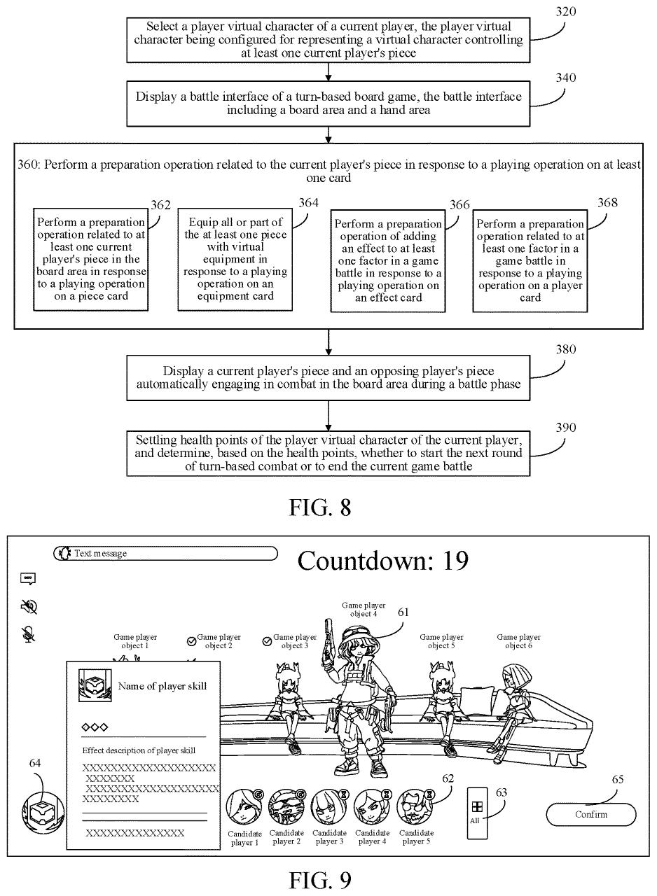

FIG. 8 illustrates a flowchart of a battle interaction method for a turn-based board game provided by an embodiment of this disclosure. In an embodiment, an example in which the method is performed by a terminal is used for description. The method includes the following operations:

### Player Selection Phase:

Operation 320: Select a current virtual player, the virtual player being configured for representing a virtual character controlling at least one current player's piece.

Before starting a game battle each time, the current game player character selects the desired virtual player. Different virtual players have different player skills. A player skill is usually related to acquiring a player card, but may alternatively be related to other game factors.

In some embodiments, for different player skills, there are some respective passive trigger mechanisms to enable the current game player character to obtain some cards with special effects. For example, the skill effect of a player is that one treasure player card is obtained each time three piece cards are played. The effect of the treasure player card is that 1 point of energy is consumed, and the level of a current player's piece in the board area is specified to be increased by 2.

For example, as shown in FIG. 9, before a game battle is started, a player selection interface is displayed. The player selection interface displays virtual players selected by 6 game player objects. In one embodiment, the virtual player 61 selected by the current game player object is highlighted. Taking as an example that the current game player object is game player object 4, the virtual player selected by the game player object 4 is highlighted in a manner of standing, magnifying, and centered foreground, and the virtual players selected by other game player objects are displayed in a manner of sitting, a normal size, and being distributed on two sides.

The player selection interface displays a plurality of candidate virtual players 62, for example, candidate players 1 to 5. By swiping left or right, other candidate players may be viewed, or an “All” button 63 may be clicked/tapped on to view all candidate players.

The player selection interface further displays a player skill button 64. In response to the player skill button 64 being clicked/tapped on, the name and effect description of the player skill of the currently selected virtual player can be viewed in a pop-up window on the right.

In one embodiment, messages transmitted by other game players, as well as a countdown for selecting a player or entering the battle, are displayed at the top of the player selection interface. On the left side of the player selection interface, a button for transmitting text messages, a speaker on/off button, and a microphone on/off button are displayed. After the virtual player selected by the current game player object is determined, a “Confirm” button 65 may be clicked/tapped on to enter a ready state.

The n game player objects participating in a game battle engage in turn-based combat in pairs. Each turn includes a preparation phase and a battle phase.

The preparation phase of each turn includes the following operations:

Operation 340: A battle interface of a turn-based board game is displayed, the battle interface including a board area and a hand area.

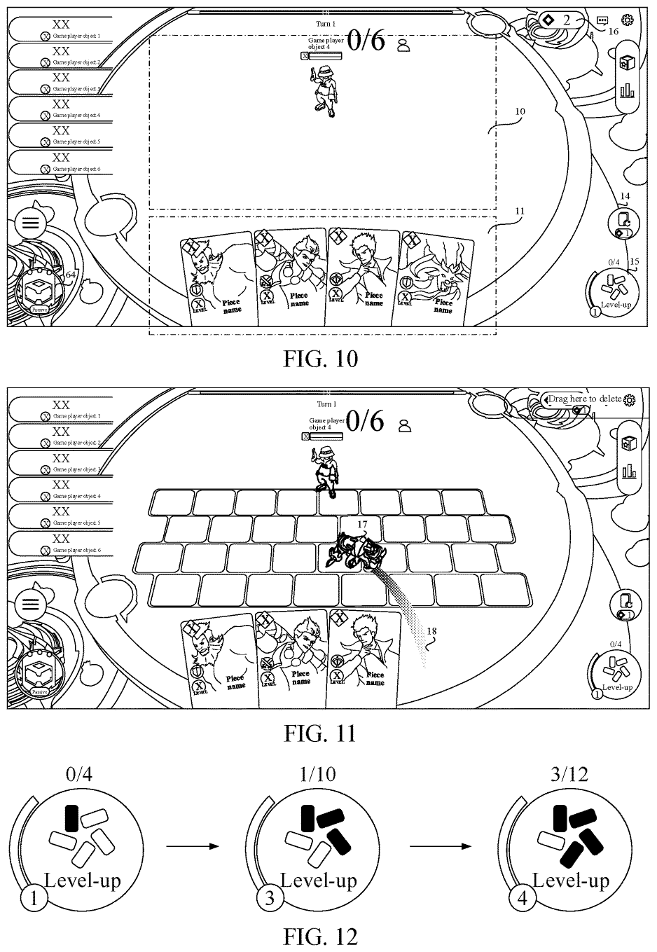

Referring to FIG. 10, the board area 10 is configured for holding at least one current player's piece and at least one opposing player's piece. In one embodiment, the upper half of the board area 10 is configured for holding the at least one opposing player's piece, and the lower half of the board area 10 is configured for holding the at least one current player's piece. The hand area 11 is configured to display at least one card held by the current game player object. In an initial state or in particular situations (e.g., when all cards in the current turn have been played), the number of cards displayed in the hand area 11 is 0.

In one embodiment, attribute information of the n game player objects participating in the current game battle is further displayed in the upper left corner of the battle interface. The attribute information includes at least one of a nickname, an avatar, hit points, or a level of the game player. A player skill button 64 is displayed in the lower left corner of the battle interface. A card exchange button 14 and a level-up button 15 are further displayed in the lower right corner of the battle interface. The card exchange button 14 is configured to replace one or more cards in the hand area 11. The level-up button 15 is configured to raise the level of the virtual player, so as to unlock higher-level cards, abilities, and obtain equipment.

In one embodiment, an energy control 16 is further displayed in the upper right corner of the battle interface. The energy control 16 is configured to display the energy value possessed by the current game player object. Energy is a game resource that may be consumed in various links throughout the entire game battle. For example, energy needs to be consumed when playing a card, exchanging a card, and raising the player level.

Operation 360: Perform a preparation operation related to the current player's piece in response to a playing operation on at least one card.

The card types include at least one of the following: piece cards, equipment cards, effect cards, or player cards. The current game player object can perform preparation operations with different functions by playing different piece cards. This operation includes at least one of the following operations:

Operation 362: Perform a preparation operation related to at least one current player's piece in the board area in response to a playing operation on a piece card.

Operation 364: Equip all or part of the at least one piece with virtual equipment in response to a playing operation on an equipment card.

Operation 366: Perform a preparation operation of adding an effect to at least one factor in a game battle in response to a playing operation on an effect card.

Operation 368: Perform a preparation operation related to at least one factor in a game battle in response to a playing operation on a player card.

Since the battle conditions vary from round to round in turn-based combat, the hand of each game player object is different, and the card-playing habits of each game player object differ, the number of times and the order in which the above operations 362, 364, 366, and 368 are performed in each round of turn-based combat may vary. This is not limited in this disclosure.

### Regarding Operation 362 (Piece Card):

In some embodiments, the cards in the hand area include a first piece card. A first current player's piece is added to the board area in response to a playing operation on the first piece card. The first current player's piece is a piece corresponding to the first piece card. In some embodiments, the first current player's piece is a piece that has not been summoned to the board area.

To be specific, the first current player's piece is added to the board area in response to the playing operation on the first piece card when the first current player's piece is not present in the board area.

At least two candidate grid cells are displayed in the board area, and a first indicator element corresponding to the first piece card is displayed, in response to the playing operation on the first piece card. The first indicator element includes at least one of a scaled-down first piece card, a first current player's piece, or a first indicator arrow. The first current player's piece is added to a first candidate grid cell in response to a dragging operation of dragging the first indicator element to the first candidate grid cell, where the first candidate grid cell is one of the at least two candidate grid cells.

The at least two candidate grid cells may be all candidate grid cells, or may be candidate grid cells belonging only to the current player. The at least two candidate grid cells may always be displayed, or may be displayed only when a playing operation is recognized.

Taking as an example that the first piece card is the fourth card in FIG. 10, referring to FIG. 11, a first current player's piece 17 and a first indicator arrow 18 are displayed in response to a dragging operation on the first piece card. The first current player's piece 17 is a three-dimensional piece that slides following the real-time position of the dragging operation. The start point of the first indicator arrow 18 is the position of the first piece card before being played, and the end point thereof is the real-time position of the dragging operation. When the release position of the dragging operation is within the first candidate grid cell, the first current player's piece 17 is summoned to the first candidate grid cell.

As shown in FIG. 11, in this interaction manner, the piece preparation area is eliminated, and the hand area simultaneously serves both piece acquisition and preparation functions, thereby enabling a plurality of functions to share one display area and improving the human-computer interaction efficiency.

In some embodiments, the cards in the hand area include a second piece card. The level of a second current player's piece is raised in the board area in response to a playing operation on the second piece card and the second current player's piece being already present in the board area. The second current player's piece is a piece corresponding to the second piece card.

The playing operation on the second piece card may be a dragging operation. However, since the second current player's piece is already present in the board area, the release position of the dragging operation may be anywhere in the board area for the operation to be completed, and it may take effect without requiring the current game player object to precisely drag it onto the second current player's piece.

### Regarding Operation 364 (Equipment Card):

In some embodiments, the cards in the hand area include an equipment card. A second indicator element corresponding to the equipment card is displayed in response to a playing operation on the equipment card. The second indicator element includes at least one of a scaled-down equipment card, virtual equipment corresponding to the equipment card, or a second indicator arrow.

The second current player's piece is equipped with the virtual equipment in response to a dragging operation of dragging the second indicator element onto the second current player's piece.

The second current player's piece is a current player's piece already present in the board area.

### Regarding Operation 366 (Effect Card):

In some embodiments, the cards in the hand area include an effect card. An effect is added to at least one current player's piece, and/or an effect is added to the card acquisition process, in response to a playing operation on the effect card.

According to the target of the effect, effect cards are divided into two types:
type 1: adding an effect to a current player's piece within the board area; and
type 2: adding an effect to the card acquisition process.

In response to a playing operation on an effect card of type 1, an effect is added to at least one current player's piece. For example, a piece type specific buff is added, or a combined buff is added when at least two pieces of the same faction are present on the board.

In response to a playing operation on an effect card of type 2, an effect is applied to the card acquisition process. For example, two identical piece cards are drawn consecutively.

### Regarding Operation 368 (Player Card):

In response to a playing operation on the player card, at least one of the following preparation operations is performed:
adding a current player's piece, removing a current player's piece, leveling up a current player's piece, adding an effect to a current player's piece, equipping a current player's piece with an item; an operation related to card acquisition, an operation related to card selling, an operation related to card exchange, an operation related to a subsequent turn, and an operation related to the health points of the current game player object.

To be specific, the function of the player card is relatively special, and may be any function among those of a piece card, an equipment card, or an effect card. It may alternatively be a function related to the card acquisition process, or a function related to the health points of the player. In different design implementations, any function that can affect a particular factor in the game battle may be designed as the function of the player card. This is not limited in this disclosure.

During the preparation phase, the current game player object may alternatively use at least one of a card exchange function, a card deletion function, or a player level-up function.

### Card Exchange Function:

During the preparation phase, the current game player object may alternatively exchange one or more cards in the hand area. By clicking/tapping on the card exchange button, one or more cards are exchanged. Exchanging cards consumes energy. For example, cards can be exchanged only once per turn, and a plurality of cards can be exchanged at a time. Regardless of the number of cards exchanged, one energy point is consumed.

### Card Deletion Function:

During the card playing process, dragging a card to a designated position allows the card to be deleted or sold. The resources consumed by the removed card may not be recovered, or may be partially recovered, or a fixed amount of energy may be recovered. For example, removing a card may yield one energy point.

### Player Level-Up Function:

The current game player object gains a particular amount of energy per turn. Any energy not used in the current turn can be carried over to the next turn. Energy can be used to raise the player level. The higher the player level, the higher the quality of the card that can be drawn per turn. Meanwhile, new capabilities such as talents or purchasable equipment may be unlocked. In one embodiment, the level-up button 15 may display quality indicators of different colors. As the player level is raised, the quality indicator corresponding to the current player level may be lit up to indicate the card quality that can be obtained at the current player level. The quality indicator may be, for example, a small circular rectangle as shown in FIG. 12, or may be in other shapes or forms.

For example, when the current game player object is at player level 1, 2, 3, 4, or 5, cards of quality 1, 2, 3, 4, or 5 may be unlocked respectively.

The battle phase of each turn includes the following operations:

Operation 380: Display that the current player's piece and the opposing player's piece automatically engage in combat in the board area during the battle phase.

The automatic combat process between the current player's piece and the opposing player's piece in the board area does not require manual control by the current game player object. Instead, the client or server automatically controls the combat between the pieces on both sides based on at least one factor such as the grid cell positions of the pieces on both sides on the board, piece attributes, piece levels, piece skills, piece attributes, and combined enhancement attributes between pieces, until all pieces on one side are defeated.

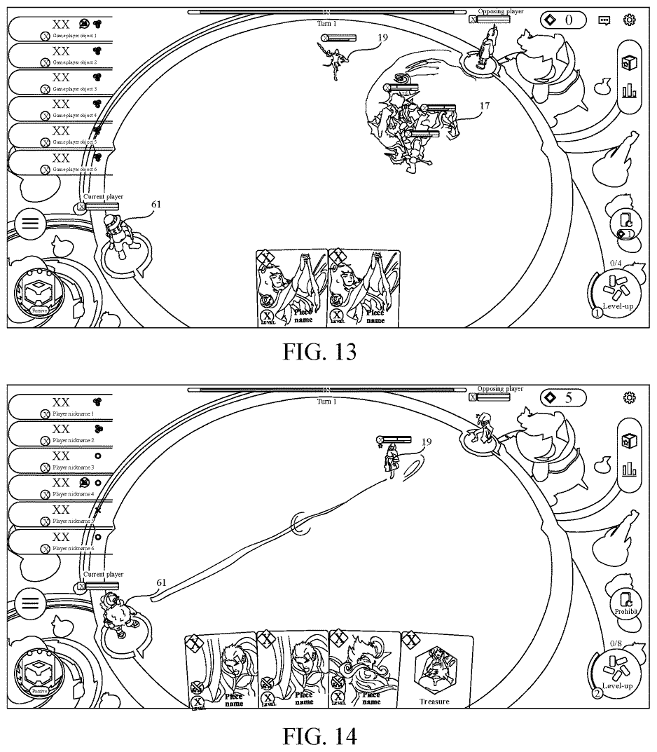

FIG. 13 illustrates a schematic diagram of automatic combat between a current player's piece 17 and an opposing player's piece 19 in the board area. None of the actions such as movement, skill casting, and functions of pieces on both sides during the combat process need to be manually controlled by game players.

A combat settlement phase includes the following operations:

Operation 390: Settle health points of the current virtual player, and based on the health points, determine whether to start the next round of turn-based combat or to end the current game battle.

Both the current game player object and the opposing game player object have health points. After the current turn ends, the health points of the game player object on the losing side will be deducted by a particular amount. The particular amount may be determined based on the number of remaining pieces on the winning side, or may be a fixed value. This is not limited in this disclosure.

When the health points are reduced to zero, the game player object is eliminated from the current game battle.

If the health points have not been reduced to zero, the game proceeds to the next round of turn-based combat within the current game battle, and the game player object continues to battle against one of the n game player objects until it is eliminated, or until it becomes the last remaining non-eliminated side and wins the current game battle.

In some embodiments, the settled damage is determined based on the number of remaining pieces on the winning side on the board. FIG. 14 illustrates that an animation effect for settling the health points of the virtual piece 61 of the current player when the current player is on the losing side and one opposing player's piece 19 remains. A health point progress bar may be displayed above the head of the virtual piece 61.

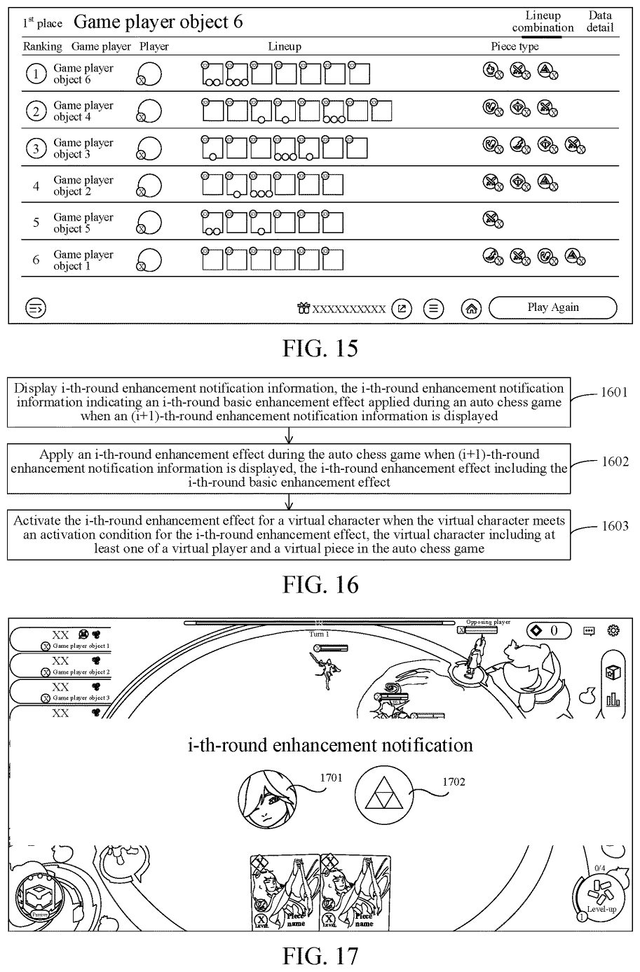

For example, referring to FIG. 15, settlement information of the current game battle is displayed on a settlement interface. The settlement information includes information such as game player rankings, and the player, the lineup, and the piece type used by each game player.

Accordingly, the method provided in an embodiment introduces a “card” mechanism into the turn-based board game, simplifying and integrating various preparation operations into the process of playing a plurality of cards. The concept of a store is eliminated, and the game player no longer needs to perform a plurality of interactions between sub-areas such as a store, a piece preparation area, and a piece battle area on a traditional battle interface to complete the acquisition, leveling up, and battling of pieces. The traditional process of purchasing pieces that required active selection by the user is replaced by passively receiving dealt cards, whereby the game system performs part of the tedious operations on behalf of the user. The user only needs to perform playing operations substantially similar to those in card games to complete various preparation operations. Thus, the human-computer interaction efficiency is improved.

In particular, when operating the turn-based board game on a small-screen terminal such as a mobile phone or a tablet, the game player can complete various preparation operations based on limited operations within the hand area. Compared to traditional auto chess, the human-computer interaction efficiency is improved.

According to the method provided in an embodiment, with piece cards, the store in traditional auto chess can be eliminated based on the playstyle characteristics of the cards. The cumbersome process in which users previously needed to purchase their desired pieces from dozens of available pieces in the store is replaced with a process in which the game system automatically deals a few cards to the game player. This eliminates the need for users to manually select cards themselves, thereby reducing the number of interactive operations required for users to acquire pieces, as well as the amount of information that users need to process.

According to the method provided in an embodiment, with the effect cards, the effect buttons or controls in traditional auto chess can be eliminated. With the equipment cards, the neutral creep round in traditional auto chess can be eliminated. With the player cards, gameplay characteristics related to players can be integrated. By simplifying different mechanisms in the turn-based board game into the card playing process based on different types of cards, the number of user interface elements that need to be displayed on the battle interface can be reduced, and the time required for the user to actively locate the relevant function entry is reduced. Besides, the operations for the current game player object can further be simplified, thereby improving the human-computer interaction efficiency for the current game player object.

In conjunction with the above description of the basic gameplay mechanics of the turn-based board game, the following describes the method for activating an enhancement effect in an auto chess provided in this disclosure.

In a related technology, to increase the diversity of auto chess games, a plurality of enhancement effect options are typically presented to a game player at specific turns for the game player to select. Then, according to the game player's selection result, the enhancement effect corresponding to the game player's selection result is activated for the virtual player or virtual piece used by the game player. However, because the selected enhancement effect is activated only for the virtual player or virtual piece used by the game player, and there are significant differences among different enhancement effects, this leads to significant disparities in strength among a plurality of game players in an auto chess game, resulting in a clear fairness problem during the auto chess game. In contrast, in the method for activating an enhancement effect in an auto chess provided in one or more embodiments of this disclosure, by setting up and applying a plurality of rounds of enhancement effects during the auto chess game, the disparities in strength among game players in the auto chess game are reduced, thereby improving the fairness of the auto chess game.

The method for activating an enhancement effect in an auto chess provided in this disclosure may be performed by a terminal, or jointly performed by a server and a terminal.

In one embodiment, in a case that this method is performed by a terminal, the terminal displays i-th-round enhancement notification information in the interface thereof after determining the i-th-round enhancement notification information, and applies an i-th-round enhancement effect during an auto chess game after determining (i+1)-th-round enhancement notification information and when displaying the (i+1)-th-round enhancement notification information. Thus, the terminal activates the i-th-round enhancement effect for a virtual character in a case that the virtual character meets an activation condition for the i-th-round enhancement effect.

In one embodiment, in a case that this method is jointly performed by a server and a terminal, the terminal displays i-th-round enhancement notification information in the interface thereof after acquiring the i-th-round enhancement notification information from the server, and applies an i-th-round enhancement effect during an auto chess game after acquiring (i+1)-th-round enhancement notification information from the server and when displaying the (i+1)-th-round enhancement notification information. Moreover, the terminal further needs to acquire an activation condition for the i-th-round enhancement effect from the server, and activates the i-th-round enhancement effect for a virtual character in a case that the virtual character meets the activation condition for the i-th-round enhancement effect.

In an embodiment of this disclosure, an example in which the method is performed by the terminal is used for illustration.

FIG. 16 is a flowchart of a method for activating an enhancement effect in an auto chess according to an embodiment of this disclosure. This embodiment is described by using an example in which the method is performed by a terminal. A program client supporting a turn-based board game runs on the terminal. The method includes the following operations:

Operation 1601: Display i-th-round enhancement notification information, the i-th-round enhancement notification information indicating an i-th-round basic enhancement effect applied during an auto chess game when an (i+1)-th-round enhancement notification information is displayed, and i being greater than or equal to 1.

In some embodiments, virtual players in an auto chess game may be divided into a current virtual player and an opposing virtual player. Each virtual player may be configured with at least one virtual piece. Thus, the virtual players arrange the virtual pieces during the auto chess game, and the virtual pieces automatically battle, so that results of the auto chess game may be produced.

In one embodiment, the virtual players may be randomly assigned by the system at the start of the auto chess game, or may be selected and determined by game players themselves. The embodiments of this disclosure do not impose limitations on this.

In one embodiment, during an auto chess game, a virtual player may possess a plurality of identical virtual pieces, a plurality of virtual pieces of the same type, or a plurality of virtual pieces of different types. Different virtual pieces correspond to different piece skills, and the virtual pieces of the same type may have similar piece skills.

In one embodiment, a virtual player may obtain a virtual piece by spending a virtual economic value, by random drawing, by reaching a particular player attribute value, or in other possible ways during the auto chess game. The embodiments of this disclosure do not impose limitations on this.

In some embodiments, to apply a plurality of rounds of enhancement effects during an auto chess game and improve the strategic depth of the battle, the terminal may, using enhancement notification rounds as units, and before applying the enhancement effect of each round, provide a notification of the enhancement effect of the current round when the enhancement notification information of the previous round is displayed. Thus, before applying the enhancement effect of the current round, a game player may arrange virtual pieces via a virtual player and adjust a battle strategy in advance based on the enhancement effect to be applied.

In a possible implementation, the terminal displays i-th-round enhancement notification information. The i-th-round enhancement notification information indicates an i-th-round basic enhancement effect applied during an auto chess game when an (i+1)-th-round enhancement notification information is displayed, where i is greater than or equal to 1 and is a positive integer.

In one embodiment, the i-th-round basic enhancement effect may be either a player enhancement effect applied to a virtual player or a piece enhancement effect applied to a virtual piece. The player enhancement effect may enhance the virtual economy of the virtual player, or enhance the player skill of the virtual player, or may be other effects that can enhance the virtual player. The piece enhancement effect may enhance the piece skill of the virtual piece, or jointly enhance virtual pieces of the same type, or may be other effects that can enhance the virtual piece.

In one embodiment, the i-th-round basic enhancement effect may include a plurality of enhancement effects, and different enhancement effects may be displayed using different enhancement effect identifiers. The player enhancement effect may correspond to different enhancement effect identifiers based on enhancement effect types. For instance, an enhancement effect that increases a virtual economic value may be displayed using a virtual economy identifier. Piece enhancement effects may be distinguished by piece images corresponding to different virtual pieces. The piece image may be at least one of an avatar, an icon, a half-body portrait, a full-body portrait, or a presentation animation of the virtual piece.

For example, as shown in FIG. 17, the terminal displays i-th-round enhancement notification information in an auto chess game interface. The i-th-round enhancement notification information indicates a first enhancement effect 1701 and a second enhancement effect 1702, where the first enhancement effect 1701 is an enhancement effect activated for a virtual player indicated by an icon, and the second enhancement effect 1702 is a skill-type enhancement effect applied to an auto chess game.

Operation 1602: Apply an i-th-round enhancement effect during the auto chess game when (i+1)-th-round enhancement notification information is displayed, the i-th-round enhancement effect including the i-th-round basic enhancement effect. In some examples, one or more i-th-round enhancement effects are applied during the auto chess game when (i+1)-th-round enhancement notification information is displayed, the one or more i-th-round enhancement effects including the i-th-round basic enhancement effect.

In some embodiments, to allow the game player to adaptively adjust the game strategy based on the i-th-round enhancement notification information during the auto chess game, the terminal may set an appropriate battle duration or a game state achievement process between the display of the i-th-round enhancement notification information and the display of the (i+1)-th-round enhancement notification information. Then, in a case that a display condition for the (i+1)-th-round enhancement notification information is met, the terminal displays the (i+1)-th-round enhancement notification information, and applies the i-th-round enhancement effect during the auto chess game when displaying the (i+1)-th-round enhancement notification information.

In one embodiment, the i-th-round enhancement effect includes at least an i-th-round basic enhancement effect, and may further include an additional enhancement effect to increase the excitement of the battle. The additional enhancement effect may be a hidden enhancement effect randomly preset by the terminal, or an enhancement effect additionally added based on the state of the auto chess game before the i-th-round basic enhancement effect is applied.

In one embodiment, the i-th-round enhancement effect applied during the auto chess game refers to an enhancement effect applied to virtual players or virtual pieces in the auto chess game. To be specific, any virtual player or virtual piece in the auto chess game has the opportunity to activate the i-th-round enhancement effect.

In one embodiment, the i-th-round enhancement effect may refer to enhancing a buff produced by a player card or piece card when the player card or piece card is used. For example, if the buff of a player card is to increase the number of piece cards acquired by the current player by 5, the enhancement effect may be to further increase the number of piece cards acquired by the current virtual player by another 5. For another example, if the buff of a piece card is to level up the equipment of a current player's virtual piece by one level, the enhancement effect may be to level up the equipment of the current player's virtual piece by one more level

Operation 1603: Activate the i-th-round enhancement effect for a virtual character in a case that the virtual character meets an activation condition for the i-th-round enhancement effect, the virtual character including at least one of a virtual player or a virtual piece in the auto chess game. In some examples, one of the applied one or more i-th-round enhancement effects is activated for a virtual character when the virtual character meets an activation condition of the one of the one or more i-th-round enhancement effects, the virtual character corresponding to a target virtual player or a target virtual piece in the auto chess game.

In some embodiments, when the (i+1)-th-round enhancement notification information is displayed and after the i-th-round enhancement effect is applied during the auto chess game, the virtual players and the virtual pieces in the auto chess game have the opportunity to activate the i-th-round enhancement effect activated. Therefore, to improve battle fairness while optimizing competitive battle strategies, the terminal may further set the activation condition corresponding to the i-th-round enhancement effect. Thus, the terminal activates the i-th-round enhancement effect for a virtual character only when the virtual character meets the activation condition.

In one embodiment, the virtual character may include at least one of the virtual player and the virtual piece in the auto chess game. The terminal activates an i-th-round player enhancement effect for the virtual player in a case that the virtual player meets an activation condition for the i-th-round player enhancement effect. The terminal activates an i-th-round piece enhancement effect for the virtual piece in a case that the virtual piece meets an activation condition for the i-th-round piece enhancement effect.

Accordingly, in one or more embodiments of this disclosure, during the auto chess game, the i-th-round enhancement notification information is displayed, and a notification is provided in advance on the i-th-round basic enhancement effect applied during the auto chess game when the (i+1)-th-round enhancement notification information is displayed. Thus, the i-th-round enhancement effect is applied during the auto chess game when the (i+1)-th-round enhancement notification information is displayed. Besides, the i-th-round enhancement effect is activated for the virtual character in a case that the virtual character meets the activation condition for the i-th-round enhancement effect. To be specific, a notification will be provided in advance for the enhancement effect applied in each round when the enhancement notification of the previous round is provided. Thus, between the display of the i-th-round enhancement notification information and the display of the (i+1)-th-round enhancement notification information, a game player can properly adjust a battle strategy based on the i-th-round enhancement notification information, thereby improving the strategic depth of the auto chess game. Moreover, as long as a virtual character meets an activation condition for an enhancement effect, the enhancement effect can be applied to the virtual character. Thus, the fairness of enhancement effect activation during the auto chess game is enhanced.

In some embodiments, to further increase the diversity of auto chess games, when displaying the (i+1)-th-round enhancement notification information, in addition to applying the i-th-round basic enhancement effect during the auto chess game, the terminal may determine an i-th-round additional enhancement effect according to the enhancement effect triggered by the virtual player during the auto chess game between the display of the i-th-round enhancement notification information and the display of the (i+1)-th-round enhancement notification information.

Furthermore, after a target virtual player triggers the i-th-round additional enhancement effect, the terminal immediately activates the i-th-round additional enhancement effect for the target virtual player or for a target virtual piece configured for the target virtual player, and simultaneously adds the i-th-round additional enhancement effect to the i-th-round enhancement effect. Thus, when the (i+1)-th-round enhancement notification information is displayed, the i-th-round enhancement effect is applied during the auto chess game. The i-th-round enhancement effect includes both the i-th-round basic enhancement effect and the i-th-round additional enhancement effect.

The following embodiments will describe the process of determining and applying the i-th-round additional enhancement effect.

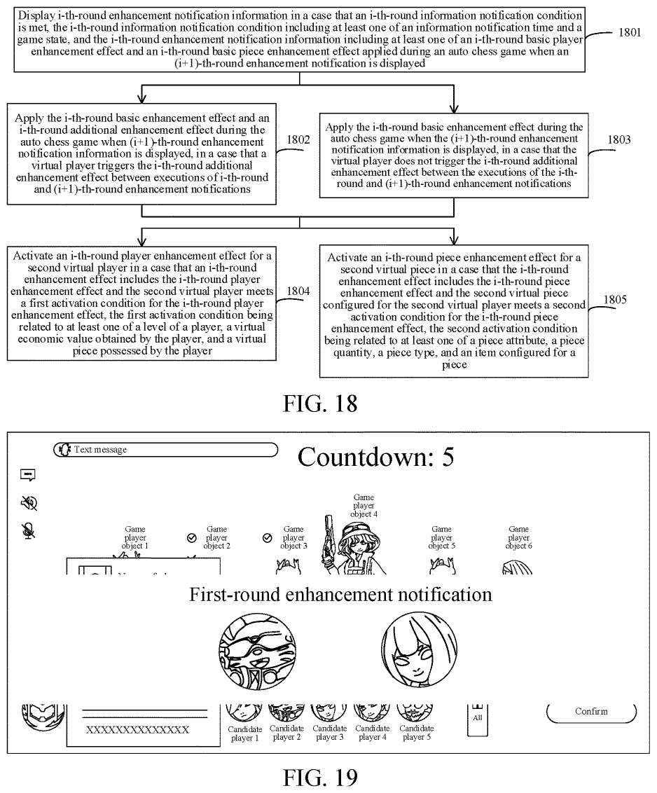

FIG. 18 is a flowchart of a method for activating an enhancement effect in an auto chess according to another embodiment of this disclosure. This embodiment is described by using an example in which the method is performed by a terminal. A program client supporting a turn-based board game runs on the terminal. The method includes the following operations:

Operation 1801: Display the i-th-round enhancement notification information in a case that an i-th-round information notification condition is met, the i-th-round information notification condition including at least one of an information notification time or a game state, and the i-th-round enhancement notification information indicating at least one of an i-th-round basic player enhancement effect or an i-th-round basic piece enhancement effect applied during the auto chess game when the (i+1)-th-round enhancement notification information is displayed.

To improve the orderliness of displaying the enhancement notification information, the terminal may set the information notification condition for the enhancement notification information of each round. Thus, the enhancement notification information is displayed in a case that the corresponding information notification condition is met.

In a possible implementation, when the i-th-round information notification condition is met, the terminal displays the i-th-round enhancement notification information, where the i-th-round enhancement notification information may include at least one of an i-th-round basic player enhancement effect or an i-th-round basic piece enhancement effect applied during the auto chess game when the (i+1)-th-round enhancement notification information is displayed.

In one embodiment, the i-th-round information notification condition may be related to at least one of an information notification time and a game state. In a possible implementation, the terminal displays the enhancement notification information at the start of each turn during the auto chess game. In another possible implementation, the terminal displays the enhancement notification information when the virtual player reaches a particular player level during the auto chess game.

In one embodiment, the basic player enhancement effect may increase the virtual economy of the player, e.g., add an additional virtual reward value when the virtual player obtains a virtual reward value. The basic player enhancement effect may enhance a player's virtual skill, e.g., add an additional virtual skill effect when the virtual player uses a virtual skill. Other player enhancement effects may alternatively be possible. This is not limited in this disclosure.

In one embodiment, the basic piece enhancement effect may enhance a piece's virtual skill, e.g., add an additional virtual skill effect when a virtual piece casts a piece skill. The basic piece enhancement effect may increase piece synergy, e.g., simultaneously control other virtual pieces of the same type to cast piece skills when controlling a virtual piece to cast a piece skill. Other piece enhancement effects may alternatively be possible. This is not limited in this disclosure.

By setting the information notification condition for the enhancement notification information of each round, the i-th-round enhancement notification information may be displayed in a case that the i-th-round information notification condition is met. Thus, the display process of the enhancement notification information of each round can be optimized, and the orderliness of displaying the enhancement notification information can be improved.

In some embodiments, the enhancement notification information of each round and the corresponding information notification condition may be pre-configured at the start of the auto chess game, or the i-th-round enhancement effect may be dynamically determined according to the enhancement effects of the first (i−1) rounds during the auto chess game.

In a possible implementation, when an auto chess game is started, the terminal may determine enhancement notification configuration information corresponding to the auto chess game from an enhancement notification strategy library. The enhancement notification configuration information may include an information notification time of each round and an enhancement notification information of each round.

In one embodiment, the enhancement notification strategy library may include a plurality of enhancement effects and enhancement effect combination strategies. In a possible implementation, the terminal may determine a plurality of enhancement effect combinations corresponding to the auto chess game according to player attributes of virtual players in the auto chess game and the enhancement effect combination strategies. Thus, the terminal sorts the enhancement effect combinations based on combination weights, and determines the enhancement notification configuration information corresponding to the auto chess game according to the sorting result and the total number of enhancement notification rounds. The enhancement notification configuration information may include the first n enhancement effect combinations in the sorting result, n being the total number of enhancement notification rounds and being a positive integer.

For example, as shown in Table 1, the terminal first obtains a plurality of random enhancement effect combinations corresponding to the current battle from the enhancement notification strategy library according to the player types of the virtual players in the auto chess game. Then, the terminal sorts the enhancement effect combinations according to the combination weights, thereby determining the target enhancement effect combination corresponding to the current auto chess game.

TABLE 1

| Random Enhancement | Combination | Target Enhancement |
|---|---|---|
| Effect Combination | Weight | Effect Combination |
| Random | Weight | Enhancement |
| combination 1 | value 1 | notification |
| | | information 1 |
| Random | Weight | Enhancement |
| combination 2 | value 2 | notification |
| | | information 2 |
| Random | Weight | Enhancement |
| combination 3 | value 3 | notification |
| | | information 3 |

In another possible implementation, considering that during a battle, a virtual player may trigger an additional enhancement effect, and the additional enhancement effect may coincide with a pre-configured basic enhancement effect, to improve the application diversity of the enhancement effect, the terminal may first determine first-round enhancement notification information and an information notification time corresponding to an enhancement notification of each round from the enhancement notification strategy library when the auto chess game is started. Then, the terminal may determine the (i+1)-th-round enhancement notification information based on additional enhancement effects of the first i rounds and enhancement notification information of the first i rounds before the (i+1)-th-round enhancement notification information is displayed, such that the (i+1)-th-round enhancement notification information is different from the enhancement notification information of the first i rounds and does not include the additional enhancement effects of the first i rounds.

In one embodiment, the terminal first determines the additional enhancement effects of the first i rounds and the enhancement notification information of the first i rounds before displaying the (i+1)-th-round enhancement notification information, and then determines the (i+1)-th-round enhancement notification information of the (i+1)-th-round enhancement notification from other enhancement effects than the additional enhancement effects of the first i rounds and the enhancement notification information of the first i rounds in the enhancement notification strategy library. For instance, the first-round enhancement notification information indicates enhancement effect 1, and a first-round additional enhancement effect is enhancement effect 2. The terminal determines, as the (i+1)-th-round enhancement notification information, at least one enhancement effect from other enhancement effects than the enhancement effect 1 and the enhancement effect 2 in the enhancement notification strategy library.

Since the information notification time corresponding to the enhancement notification of each round is determined when the auto chess game is started, the enhancement notification information can be displayed based on the time condition, thereby further improving the orderliness of displaying the enhancement notification information. Furthermore, since the (i+1)-th-round enhancement notification information is determined according to the additional enhancement effects of the first i rounds and the enhancement notification information of the first i rounds, the diversity of enhancement effect applications can be increased, and the effect of the auto chess game can be improved.

In some embodiments, considering that the terminal will apply the i-th-round enhancement effect during the auto chess game when displaying the (i+1)-th-round enhancement notification information, to apply the i-th-round enhancement effect, a game player can view the i-th-round enhancement effect to be applied again, and the terminal may add the i-th-round enhancement effect to be applied at the current battle moment to the (i+1)-th-round enhancement notification information.

In a possible implementation, when a first-round enhancement notification information is displayed, the first-round enhancement notification information displayed by the terminal may include a first-round basic enhancement effect to be applied during the auto chess game when a second-round enhancement notification information is displayed. When the i-th-round enhancement notification information is displayed, the i-th-round enhancement notification information displayed by the terminal includes the i-th-round basic enhancement effect applied during the auto chess game when the (i+1)-th-round enhancement notification information is displayed, and an (i−1)-th-round enhancement effect applied during the auto chess game at the current battle moment, where i is greater than or equal to 2.

For example, as shown in FIG. 19, at a battle start phase, the terminal displays the first-round enhancement notification information in a battle preparation interface. The first-round enhancement notification information indicates only the first-round basic enhancement effect applied during the auto chess game when the second-round enhancement notification information is displayed.

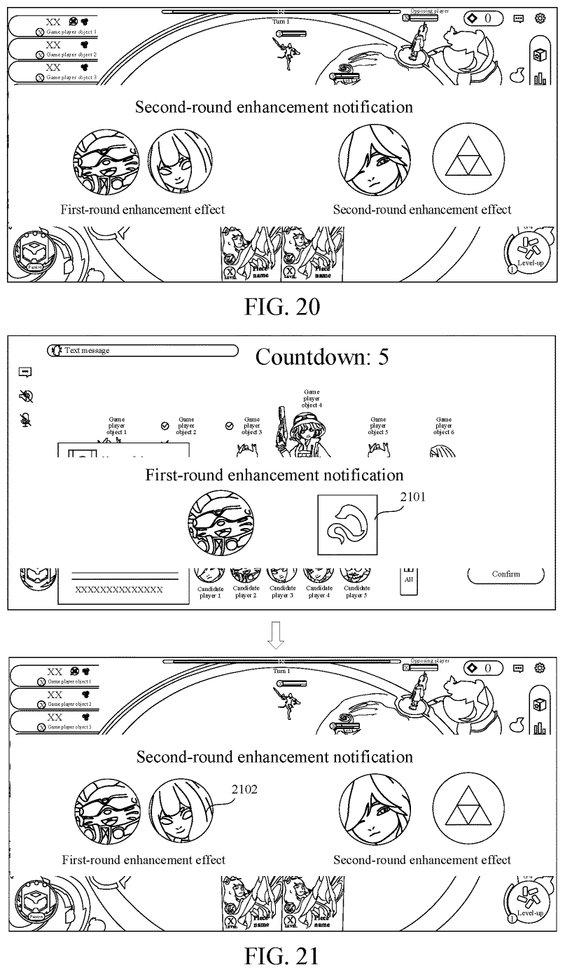

For example, as shown in FIG. 20, during the battle, when the second-round enhancement notification information is displayed, the second-round enhancement notification information displayed by the terminal includes both the first-round enhancement effect that is about to be applied during the auto chess game, and a second-round basic enhancement effect applied during the auto chess game when a third-round enhancement notification information is displayed.

By additionally displaying, in the i-th-round enhancement notification information, the (i−1)-th-round enhancement effect that is about to be applied during the auto chess game at the current battle moment, a game player can conveniently view the enhancement effect of the previous round. Thus, the notifying effect of the enhancement notification is optimized.

In some embodiments, to increase the excitement of the battle and raise the difficulty of the battle strategy, when displaying the i-th-round enhancement notification information, the terminal may further display the i-th-round enhancement notification information in an implicit notification form, so that a game player can guess and implement the battle strategy based on the enhancement notification information in the implicit notification form. When the i-th-round basic enhancement effect is applied, a virtual player and a virtual piece controlled by a game player who guesses correctly will have a higher chance to meet an activation condition for the i-th-round basic enhancement effect, and a virtual player and a virtual piece controlled by a game player who guesses incorrectly will have a smaller chance to meet the activation condition for the i-th-round basic enhancement effect.

In some embodiments, to reveal to the game player whether the guess is correct before the i-th-round basic enhancement effect is applied, the terminal also needs to reveal the i-th-round basic enhancement effect in the (i+1)-th-round enhancement notification information. To be specific, the i-th-round basic enhancement effect in an implicit notification state in the i-th-round enhancement notification information needs to be adjusted to an explicit notification state in the (i+1)-th-round enhancement notification information.

In a possible implementation, in a case that the i-th-round basic enhancement effect is in the implicit notification state in the i-th-round enhancement notification information, after an (i+1)-th-round information notification condition is met, the terminal displays the (i+1)-th-round enhancement notification information that includes the i-th-round basic enhancement effect in the explicit notification state. To be specific, the (i+1)-th-round enhancement notification information may include both the i-th-round basic enhancement effect in the explicit notification state and the (i+1)-th-round basic enhancement effect in the implicit notification state.

For example, as shown in FIG. 21, when displaying the first-round enhancement notification information, the terminal implicitly notifies the first-round enhancement effect by displaying a virtual piece type icon 2101. When displaying the second-round enhancement notification information, to reveal to a game player the first-round enhancement effect that is about to be applied, the terminal updates the virtual piece type icon 2101 to a piece image icon 2102, and the virtual piece indicated by the piece image icon 2102 belongs to the virtual piece type indicated by the virtual piece type icon 2101.

The i-th-round enhancement notification information is displayed in the implicit notification form when the i-th-round enhancement notification information is displayed, so that the game player can select the difficulty of the battle strategy. Thus, the battle processes are enriched. In addition, the i-th-round enhancement notification information is revealed in the explicit notification form when the (i+1)-th-round enhancement notification information is displayed. Thus, the display manners for the enhancement notification information are enriched, and the information display process is optimized.

Operation 1802: Apply the i-th-round basic enhancement effect and the i-th-round additional enhancement effect during the auto chess game when the (i+1)-th-round enhancement notification information is displayed, in a case that the virtual player triggers the i-th-round additional enhancement effect between the display of the i-th-round enhancement notification information and the display of the (i+1)-th-round enhancement notification information.

In some embodiments, to increase the diversity of triggering enhancement effects, in addition to a plurality of rounds of basic enhancement effects set by the system during the auto chess game, the terminal may further provide the virtual player with an opportunity to separately trigger the additional enhancement effect. For instance, when a first virtual player triggers an enhancement effect, the enhancement effect is immediately activated for the first virtual player, where the first virtual player is one of the virtual players in the auto chess game. To avoid significant differences in enhancement between the virtual players, the terminal may further use the enhancement effect triggered by each virtual player during the auto chess game between the display of the i-th-round enhancement notification information and the display of the (i+1)-th-round enhancement notification information as the i-th-round additional enhancement effect, and apply both the i-th-round additional enhancement effect and the i-th-round basic enhancement effect to the auto chess game when displaying the (i+1)-th-round enhancement notification information.

In a possible implementation, when the additional enhancement effect separately triggered by the first virtual player is an enhancement effect having a duration between the display of the i-th-round enhancement notification information and the display of the (i+1)-th-round enhancement notification information, the terminal activates the additional enhancement effect for the first virtual player until displaying the (i+1)-th-round enhancement notification information, and adds the timeliness of the additional enhancement effect when displaying the (i+1)-th-round enhancement notification information and applying the additional enhancement effect as the i-th-round additional enhancement effect to the auto chess game. For instance, if the first virtual player separately triggers an enhancement effect having a duration of 1 second between the display of the i-th-round enhancement notification information and the display of the (i+1)-th-round enhancement notification information, when the enhancement effect is applied to the auto chess game as the i-th-round additional enhancement effect, the enhancement effect has a duration of only 1 second once it is activated for other virtual players.

In a possible implementation, to determine whether the enhancement effect applied during the auto chess game includes the i-th-round additional enhancement effect when the (i+1)-th-round enhancement notification information is displayed, the terminal needs to determine whether the virtual player triggers the i-th-round additional enhancement effect during the auto chess game between the display of the i-th-round enhancement notification information and the display of the (i+1)-th-round enhancement notification information. In a case that the virtual player triggers the i-th-round additional enhancement effect between the display of the i-th-round enhancement notification information and the display of the (i+1)-th-round enhancement notification information, when displaying the (i+1)-th-round enhancement notification information, the terminal applies the i-th-round basic enhancement effect and the i-th-round additional enhancement effect during the auto chess game.

In one embodiment, the cases in which the virtual player triggers the i-th-round additional enhancement effect include at least two types: The first type is that an i-th-round additional player enhancement effect is activated when the first virtual player meets an activation condition for an additional player enhancement effect. The second type is that an i-th-round additional piece enhancement effect is activated when the first virtual piece configured for the first virtual player meets an activation condition for an additional piece enhancement effect.

In a possible implementation, in a case that the first virtual player meets the activation condition for the additional player enhancement effect between the display of the i-th-round enhancement notification information and the display of the (i+1)-th-round enhancement notification information, the terminal activates the i-th-round additional player enhancement effect for the first virtual player. Thus, it can be determined that the virtual player triggers the i-th-round additional enhancement effect during the auto chess game, where the first virtual player is one of the virtual players in the auto chess game.

The manner in which the first virtual player meets the activation condition for the additional player enhancement effect may be using an enhancement effect activation item, or casting an enhancement effect activation skill, or may be other manners in which the additional player enhancement effect can be activated. This is not limited in this disclosure.

In a possible implementation, in a case that the first virtual player uses the enhancement effect activation item, the terminal activates the i-th-round additional player enhancement effect for the first virtual player, and the i-th-round additional player enhancement effect is a player enhancement effect corresponding to the enhancement effect activation item. In an example, if the first virtual player uses a virtual economic value doubling item, the terminal doubles the virtual economic value corresponding to the first virtual player.

In a possible implementation, in a case that the first virtual player casts the enhancement effect activation skill, the terminal activates the i-th-round additional player enhancement effect for the first virtual player, and the i-th-round additional player enhancement effect is a player enhancement effect corresponding to the enhancement effect activation skill. In an example, if the virtual player uses a skill attack value increasing item, the terminal increases the attack value of the virtual player skill cast by the first virtual player.

The player enhancement effect produced by the virtual player using the enhancement effect activation item and the player enhancement effect produced by casting the enhancement effect activation skill between the display of the i-th-round enhancement notification information and the display of the (i+1)-th-round enhancement notification information are determined as the i-th-round additional player enhancement effect. Thus, the enhancement effect activated separately by the virtual player in the previous round may be widely applied to the next round of auto chess game. The application manners of the player enhancement effects during the battle are enriched, and the diversity of the battles is increased.

In another possible implementation, in a case that the first virtual piece configured for the first virtual player meets the activation condition for the additional piece enhancement effect between the display of the i-th-round enhancement notification information and the display of the (i+1)-th-round enhancement notification information, the terminal activates the i-th-round additional piece enhancement effect for the first virtual piece. Thus, it can be determined that the virtual player triggers the i-th-round additional enhancement effect during the auto chess game, where the first virtual piece is at least one of the virtual pieces configured for the first virtual player.

The manner in which the first virtual piece meets the activation condition for the additional piece enhancement effect may be that the first virtual player uses a piece enhancement item for the first virtual piece, or that the first virtual piece meets a piece configuration condition, or may be other manners for activating the additional piece enhancement effect. This is not limited in this disclosure.

In a possible implementation, in a case that the first virtual player uses the piece enhancement item for the first virtual piece, the terminal activates the i-th-round additional piece enhancement effect for the first virtual piece. The i-th-round additional piece enhancement effect is a piece enhancement effect corresponding to the piece enhancement item. In an example, if the virtual player uses a piece skill attack value increasing item for the first virtual piece, the terminal may increase the attack value of the virtual piece skill cast by the first virtual piece. For instance, taking as an example that the first virtual player uses “Awakening Stones” for the first virtual piece, in a case that a current player's virtual piece and an opposing player's virtual piece are in the game state and the current virtual player uses “Awakening Stones” for the current player's virtual piece, the terminal immediately activates an awakening enhancement effect corresponding to “Awakening Stones” for the current player's virtual piece, and determines the awakening enhancement effect as the additional enhancement effect.

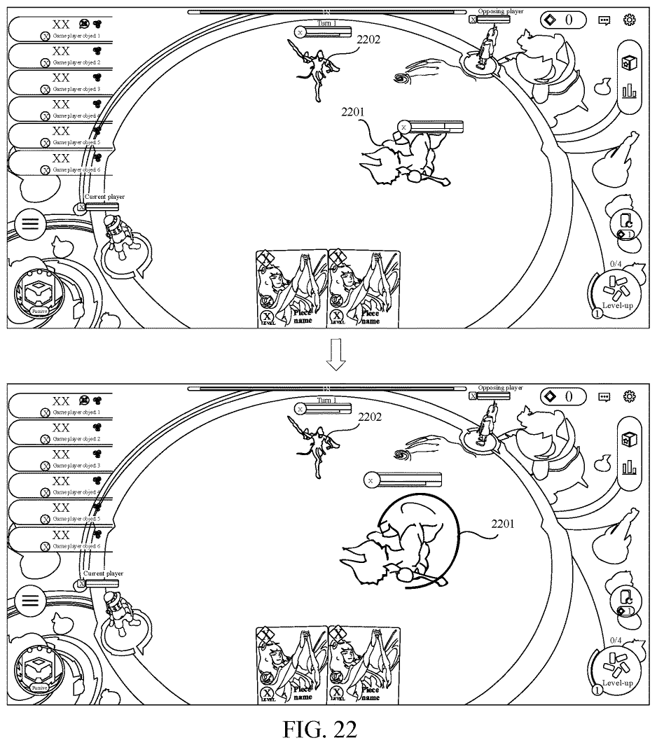

For example, as shown in FIG. 22, in a case that a current player's virtual piece 2201 and an opposing player's virtual piece 2202 are in the game state and the current virtual player uses “Awakening Stones” for the current player's virtual piece 2201, the terminal immediately activates an awakening enhancement effect corresponding to “Awakening Stones” for the current player's virtual piece 2201. In this case, the current player's virtual piece 2201 will be transitioned from a first piece state to a second piece state.

In a possible implementation, in a case that the first virtual piece configured for the first virtual player meets the piece configuration condition, the terminal activates the i-th-round additional piece enhancement effect for the first virtual piece. The i-th-round additional piece enhancement effect is a piece enhancement effect triggered by the piece configuration condition.

In one embodiment, the piece configuration condition is related to at least one of a piece configuration quantity or a piece configuration type. For instance, the piece configuration condition may be that a piece configuration quantity for identical virtual pieces meets a quantity threshold, or that a piece configuration quantity for virtual pieces of the same type meets a threshold, or that virtual pieces of all types are configured. This is not limited this disclosure.

In an example, in a case that the number of first virtual pieces configured for the first virtual player meets the quantity threshold, the terminal may increase the piece attack value of the first virtual piece. For instance, the piece attack value of the first virtual piece is increased by 5%.

The piece enhancement effect activated for the virtual piece based on the piece enhancement item and the piece enhancement effect activated based on the piece configuration condition between the display of the i-th-round enhancement notification information and the display of the (i+1)-th-round enhancement notification information are determined as the i-th-round additional piece enhancement effect. Thus, the enhancement effect activated separately for the virtual piece in the previous round may be widely applied to the next round of auto chess game. The application manners of the piece enhancement effects during the battle are enriched, and the diversity of the battles is increased.

Whether the virtual player triggers the i-th-round additional enhancement effect is determined from two perspectives: virtual player and virtual piece, thereby avoiding setting a single additional enhancement effect and increasing the diversity of the additional enhancement effects.

In some embodiments, the terminal will apply the i-th-round enhancement effect during the auto chess game when displaying the (i+1)-th-round enhancement notification information, and the i-th-round enhancement effect includes both the i-th-round basic enhancement effect indicated when the i-th-round enhancement notification information is displayed, and the i-th-round additional enhancement effect produced during the auto chess game between the display of the i-th-round enhancement notification information and the display of the (i+1)-th-round enhancement notification information. Considering this, to enable a game player to know whether there is the i-th-round additional enhancement effect in advance before the i-th-round enhancement effect is applied, the terminal may add to the (i+1)-th-round enhancement notification information the i-th-round enhancement effect that is about to be applied at the current battle moment, and the i-th-round enhancement effect includes the i-th-round additional enhancement effect.

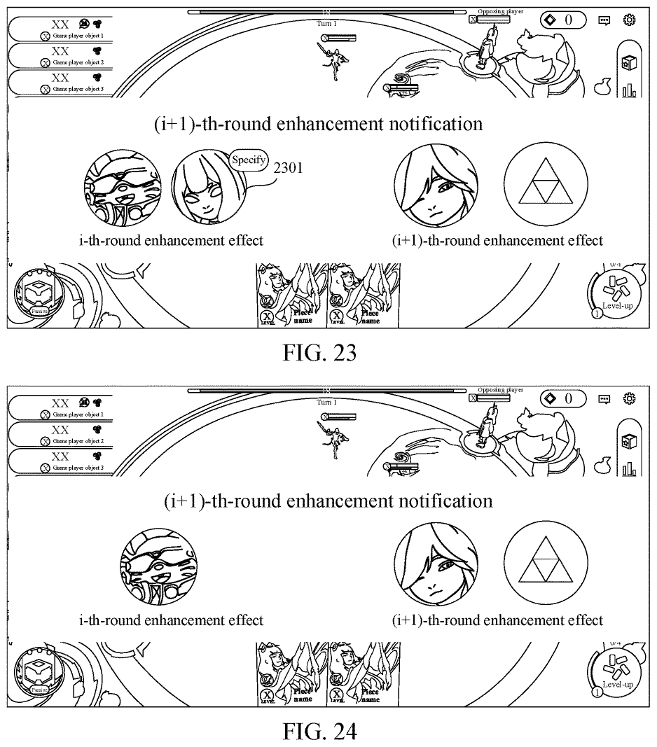

For example, as shown in FIG. 23, in a case that the virtual player triggers the i-th-round additional enhancement effect between the display of the i-th-round enhancement notification information and the display of the (i+1)-th-round enhancement notification information, the terminal may reveal the i-th-round enhancement effect in the (i+1)-th-round enhancement notification information when displaying the (i+1)-th-round enhancement notification information. In addition, for the i-th-round additional enhancement effect, the terminal may add a “Specify” flag to an enhancement effect identifier 2301 corresponding to the i-th-round additional enhancement effect.

Operation 1803: Apply the i-th-round basic enhancement effect during the auto chess game when the (i+1)-th-round enhancement notification information is displayed, in a case that the virtual player does not trigger the i-th-round additional enhancement effect between the display of the i-th-round enhancement notification information and the display of the (i+1)-th-round enhancement notification information.

In some embodiments, the terminal determines whether the virtual player triggers the i-th-round additional enhancement effect during the auto chess game between the display of the i-th-round enhancement notification information and the display of the (i+1)-th-round enhancement notification information, and applies the i-th-round basic enhancement effect during the auto chess game when displaying the (i+1)-th-round enhancement notification information in a case that the virtual player does not trigger the i-th-round additional enhancement effect.

In one embodiment, in a case that the virtual player does not trigger the i-th-round additional enhancement effect between the display of the i-th-round enhancement notification information and the display of the (i+1)-th-round enhancement notification information, when the (i+1)-th-round enhancement notification information is displayed, the i-th-round enhancement effect included in the (i+1)-th-round enhancement notification information is only the i-th-round basic enhancement effect.

For example, as shown in FIG. 24, in a case that the virtual player does not trigger the i-th-round additional enhancement effect between the display of the i-th-round enhancement notification information and the display of the (i+1)-th-round enhancement notification information, when the (i+1)-th-round enhancement notification information is displayed, the i-th-round enhancement effect includes only the i-th-round basic enhancement effect.

Operation 1804: Activate an i-th-round player enhancement effect for a second virtual player in a case that the i-th-round enhancement effect includes the i-th-round player enhancement effect and the second virtual player meets a first activation condition for the i-th-round player enhancement effect, the first activation condition being related to at least one of a level of a player, a virtual economic value obtained by the player, or a virtual piece possessed by the player.

In one embodiment, the i-th-round enhancement effect may include at least one of the i-th-round player enhancement effect or an i-th-round piece enhancement effect. The terminal activates the i-th-round player enhancement effect for the virtual player in a case that the virtual player satisfies the i-th-round player enhancement effect. The terminal activates the i-th-round piece enhancement effect for the virtual piece in a case that the virtual piece satisfies the i-th-round piece enhancement effect.

In some embodiments, in a case that the i-th-round enhancement effect includes the i-th-round player enhancement effect, the terminal needs to determine whether the virtual player meets the first activation condition corresponding to the i-th-round player enhancement effect during the auto chess game after applying the i-th-round player enhancement effect to the battle, and then activates the i-th-round player enhancement effect for the second virtual player in a case that the second virtual player meets the first activation condition for the i-th-round player enhancement effect, where the second virtual player is one of the virtual players in the auto chess game, and may be the same virtual player as the first virtual player.

In one embodiment, the first activation condition is related to at least one of the level of the player, the virtual economic value obtained by the player, or the virtual piece possessed by the player. For instance, the first activation condition may be that the level of the player reaches a level threshold, or the virtual economic value obtained by the virtual player reaches an economic value threshold, or the number of virtual pieces possessed by the player reaches a quantity threshold, etc. This is not limited in this disclosure.

In one embodiment, the i-th-round player enhancement effect may further be divided into an i-th-round basic player enhancement effect and an i-th-round additional player enhancement effect. After the i-th-round basic player enhancement effect is applied to the auto chess game, the terminal needs to determine whether each virtual player in the battle meets the first activation condition corresponding to the i-th-round basic player enhancement effect. After the i-th-round additional player enhancement effect is applied to the auto chess game, the terminal only needs to determine whether other virtual players than the virtual player triggering the i-th-round additional player enhancement effect in the battle meet the first activation condition corresponding to the i-th-round additional player enhancement effect.

Operation 1805: Activate an i-th-round piece enhancement effect for a second virtual piece in a case that the i-th-round enhancement effect includes the i-th-round piece enhancement effect and the second virtual piece configured for the second virtual player meets a second activation condition for the i-th-round piece enhancement effect, the second activation condition being related to at least one of a piece attribute, a piece quantity, a piece type, or an item configured for a piece.

In some embodiments, in a case that the i-th-round enhancement effect includes the i-th-round piece enhancement effect, the terminal needs to determine whether the virtual piece configured for the virtual player meets the second activation condition corresponding to the i-th-round piece enhancement effect during the auto chess game after applying the i-th-round piece enhancement effect to the battle, and then activates the i-th-round piece enhancement effect for the second virtual piece in a case that the second virtual piece meets the second activation condition for the i-th-round piece enhancement effect, where the second virtual piece is at least one of the virtual pieces configured for the second virtual player.

In one embodiment, the second activation condition is related to at least one of the piece attribute, the piece quantity, the piece type, or the item configured for the piece. For instance, the second activation condition may be that the piece level reaches a level threshold, or the piece quantity reaches a quantity threshold, or the piece type meets a type condition, or a specific item is used for the virtual piece. This is not limited in this disclosure.

In a possible implementation, in a case that the piece attribute of the second virtual piece meets a piece attribute condition, the terminal activates the i-th-round piece enhancement effect for the second virtual piece. The i-th-round piece enhancement effect is configured for switching the second virtual piece from a first piece state to a second piece state. In one embodiment, the second virtual piece in the first piece state only possesses a basic skill. After the i-th-round piece enhancement effect is applied to the second virtual piece, the second virtual piece in the second piece state may possess both the basic skill and an additional skill. To be specific, in a case that the second virtual player controls the second virtual piece to apply the basic skill, the second virtual piece may continue to cast the additional skill. Thus, the skill casting effect is improved. In addition, the virtual pieces of the same type in the second piece state can cast the same virtual skill at the same time. To be specific, in a case that a condition for simultaneously casting a skill is met, the virtual pieces of the same type in the second piece state may together cast the same virtual skill to an opposing player's virtual piece at the same time.

In one embodiment, to visually distinguish between the virtual piece in the first piece state and the virtual piece in the second piece state, the terminal may further set the virtual piece in the first piece state and the virtual piece in the second piece state to have two different display effects.

For example, taking as an example that the i-th-round piece enhancement effect is an awakening enhancement effect, in a case that the level of the virtual piece reaches the level threshold, the terminal may switch the virtual piece from an unawakened state to an awakened state, and the virtual piece in the awakened state has the additional skill.

Taking as an example that the current virtual player triggers the i-th-round additional enhancement effect between the display of the i-th-round enhancement notification information and the display of the (i+1)-th-round enhancement notification information and the i-th-round additional enhancement effect is to awaken the virtual piece using “Awakening Stones”, in a case that the current virtual player awakens the current player's virtual piece using. “Awakening Stones”, the terminal immediately activates an awakening enhancement skill for the current player's virtual piece and uses the awakening enhancement skill as the i-th-round additional enhancement effect. Thus, after the (i+1)-th-round enhancement notification information is displayed and the i-th-round enhancement effect is applied to the auto chess game, the terminal also activates the awakening enhancement effect for an opposing player's virtual piece when the opposing player's virtual piece meets an activation condition for the awakening enhancement effect.

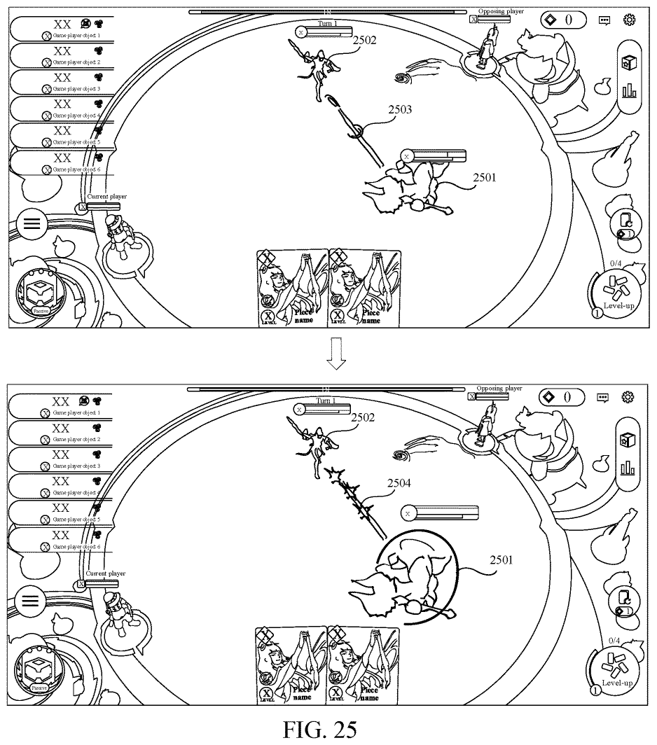

For example, as shown in FIG. 25, a current player's virtual piece 2501 and an opposing player's virtual piece 2502 are in the game state between the display of the i-th-round enhancement notification information and the display of the (i+1)-th-round enhancement notification information. The terminal switches the current player's virtual piece 2501 from a first piece state (unawakened state) to a second piece state (awakened state) in response to the current virtual player using “Awakening Stones” for the current player's virtual piece 2501. When the current player's virtual piece 2501 is in the unawakened state, the current player's virtual piece 2501 may cast the basic skill 2503 to the opposing player's virtual piece 2502. When the current player's virtual piece 2501 is in the awakened state, the current player's virtual piece 2501 may cast the basic skill and the additional skill 2504 for the opposing player's virtual piece 2502.

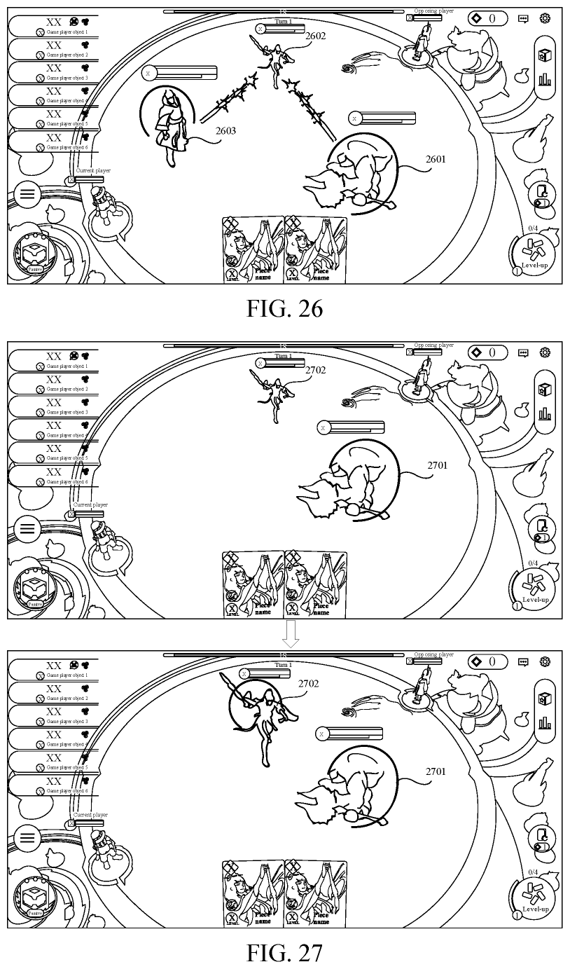

For example, as shown in FIG. 26, a current player's first virtual piece 2601 and an opposing player's virtual piece 2602 are in the game state, and a current player's second virtual piece 2603 and the current player's first virtual piece 2601 are of the same piece type and both are in the awakened state. Thus, in a case that the current player's first virtual piece 2601 is controlled to cast a special skill to the opposing player's virtual piece 2602, the current player's second virtual piece 2603 casts the special skill to the opposing player's virtual piece 2602 at the same time.

For example, as shown in FIG. 27, a current player's virtual piece 2701 and an opposing player's virtual piece 2702 are in the game state between the display of the i-th-round enhancement notification information and the display of the (i+1)-th-round enhancement notification information, and the current virtual player uses an awakening enhancement item to the current player's virtual piece 2701 for switching the current player's virtual piece 2701 to the second piece state. Then, the terminal determines an awakening enhancement effect as the i-th-round additional enhancement effect. Thus, when displaying the (i+1)-th-round enhancement notification information, the terminal applies the awakening enhancement effect to the auto chess game. Accordingly, the terminal also switches the opposing player's virtual piece 2702 to the second piece state after the opposing player's virtual piece 2702 meets the activation condition for the awakening enhancement effect.

In a possible implementation, in a case that the number of the second virtual pieces of the same piece type reaches a piece quantity threshold, the terminal activates the i-th-round piece enhancement effect for the target virtual piece of the same piece type. In an example, in a case that the number of the second virtual pieces of the same piece type reaches a piece quantity threshold, the terminal may enhance the virtual piece skill of the second virtual piece of the same piece type.

By using the piece attribute condition or the piece quantity threshold as the second activation condition for the i-th-round piece enhancement effect, the manners of activating the i-th-round piece enhancement effect can be increased, and the implementation processes of the i-th-round piece enhancement effect can be enriched.

After the i-th-round enhancement effect is applied to the auto chess game, the enhancement effect is not activated directly for the virtual player or the virtual piece. Instead, whether the enhancement effect is activated is determined according to respective activation conditions. Thus, the activation process of the enhancement effect is optimized, and the activation threshold for the enhancement effect during the auto chess game is maintained.

In one embodiment, the i-th-round piece enhancement effect may further be divided into an i-th-round basic piece enhancement effect and an i-th-round additional piece enhancement effect. After the i-th-round basic piece enhancement effect is applied to the auto chess game, the terminal needs to determine whether the virtual piece configured for each virtual player in the battle meets the second activation condition corresponding to the i-th-round basic piece enhancement effect. After the i-th-round additional piece enhancement effect is applied to the auto chess game, the terminal only needs to determine whether the virtual pieces configured for other virtual players than the virtual player triggering the i-th-round additional piece enhancement effect in the battle meet the second activation condition corresponding to the i-th-round additional piece enhancement effect.

In the foregoing embodiments, a game player intervention mechanism is provided. In a case that the virtual player triggers an enhancement effect between the display of the i-th-round enhancement notification information and the display of the (i+1)-th-round enhancement notification information, the enhancement effect is determined as the i-th-round additional enhancement effect. Thus, when the (i+1)-th-round enhancement notification information is displayed, both the i-th-round basic enhancement effect and the i-th-round additional enhancement effect are applied during the auto chess game. The diversity of enhancement effect applications is increased.

Furthermore, by setting the i-th-round enhancement notification information in the implicit notification state, a game player can make strategy guesses based on the implicit notification information. As a result, the virtual character controlled by a game player who guesses correctly will have a higher chance to activate the i-th-round enhancement effect. The excitement and strategic depth of the auto chess game are increased.

Meanwhile, by displaying the i-th-round enhancement effect again when displaying the (i+1)-th-round enhancement notification information, a further notification may be provided for the i-th-round enhancement effect that is about to be applied to the auto chess game, and the i-th-round additional enhancement effect triggered during the battle may alternatively be presented to the game player in advance. The i-th-round enhancement effect displayed in the implicit notification form when the i-th-round enhancement notification information is displayed may alternatively be revealed when the (i+1)-th-round enhancement notification information is displayed. Thus, the display effects of the enhancement notification information of each round are enriched, and the diversity of enhancement effect activation during the auto chess game is increased.

In some embodiments, considering that a plurality of rounds of enhancement effects are produced during an auto chess game and that there are display intervals between the adjacent rounds of enhancement notification information, to facilitate a game player in viewing the effect application progress of the enhancement effect of each round at any time during the battle, the terminal may set an application progress view control in the auto chess game interface, and then display an effect application progress presentation interface in response to a triggering operation of the game player on the application progress view control.

The effect application progress presentation interface includes the information notification time corresponding to the enhancement notification of each round, a player enhancement effect presentation area, and a piece enhancement effect presentation area. In addition, since there are a plurality of types of virtual pieces in an auto chess game, to improve the viewing effect, the terminal may present the piece enhancement effects based on the piece types in the piece enhancement effect presentation area.

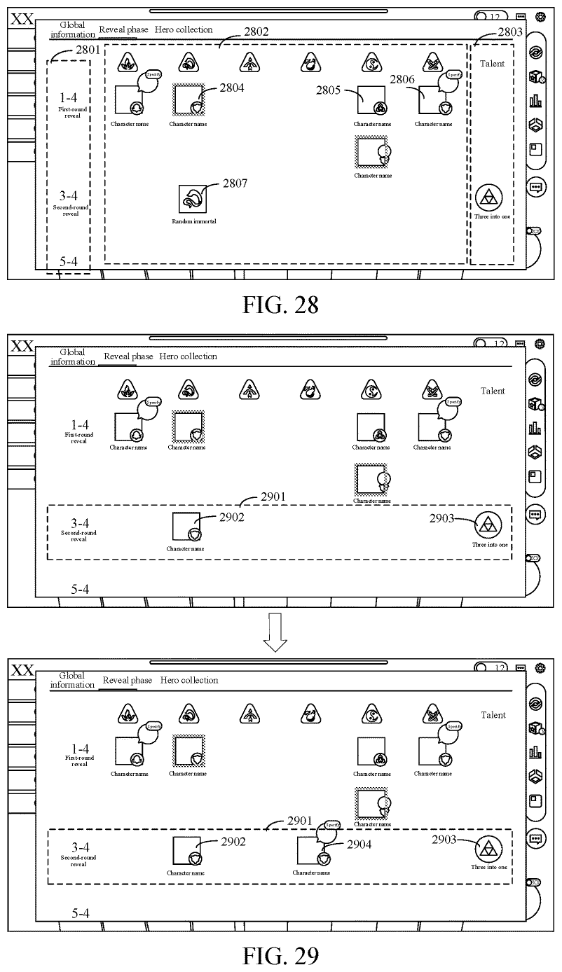

For example, as shown in FIG. 28, the terminal displays the effect application progress presentation interface in response to the triggering operation of the game player on the application progress view control. The effect application progress presentation interface includes an information notification time 2801, a player enhancement effect presentation area 2803, and a piece enhancement effect presentation area 2802, and piece enhancement effects are presented based on piece types in the piece enhancement effect presentation area 2802.

In one embodiment, to facilitate a game player in viewing the enhancement effect activated for the virtual player and the virtual piece currently controlled by the game player, the terminal may further distinguish between an applied enhancement effect and an activated enhancement effect with different display effects in the effect application progress presentation interface. To be specific, a presentation identifier for the applied enhancement effect and a presentation identifier for the activated enhancement effect have different display effects in the effect application progress presentation interface. For instance, the terminal may add a halo effect around the display identifier of an activated enhancement effect, but add no halo effect around the display identifier of an applied enhancement effect.

For example, as shown in FIG. 28, a presentation identifier 2805 corresponding to an applied enhancement effect and a presentation identifier 2804 corresponding to an activated enhancement effect have different display effects. There is no halo effect around the presentation identifier 2805 corresponding to the applied enhancement effect, and there is the halo effect around the presentation identifier 2804 corresponding to the activated enhancement effect. Furthermore, for an additional enhancement effect, the terminal adds the “Specify” flag to a presentation identifier 2806 corresponding to the additional enhancement effect. For an enhancement effect that has not been applied to the auto chess game and is indicated in an implicit notification form, the terminal displays an implicit notification identifier 2807 corresponding to the enhancement effect in the effect application progress presentation interface.

In some embodiments, considering that a virtual player may trigger the additional enhancement effect during the auto chess game, e.g., the virtual player triggers the i-th-round additional enhancement effect between the display of the i-th-round enhancement notification information and the display of the (i+1)-th-round enhancement notification information, in a case that the triggering operation of the game player on the application progress view control is received, the terminal may additionally display, in the effect application progress presentation interface, the i-th-round additional enhancement effect that is about to be applied when the (i+1)-th-round enhancement notification information is displayed.

In a possible implementation, in a case that no virtual player triggers the i-th-round additional enhancement effect before the triggering operation on the application progress view control is received, the terminal displays, in the effect application progress presentation interface, a first presentation identifier corresponding to the i-th-round basic enhancement effect in response to the triggering operation of the game player on the application progress view control.

In another possible implementation, in a case that a virtual player triggers the i-th-round additional enhancement effect before the triggering operation on the application progress view control is received, the terminal displays, in the effect application progress presentation interface, the first presentation identifier corresponding to the i-th-round basic enhancement effect and a second presentation identifier corresponding to the i-th-round additional enhancement effect in response to the triggering operation of the game player on the application progress view control.

In one embodiment, to facilitate the game player in distinguishing between a basic enhancement effect and an additional enhancement effect, the terminal may display the first presentation identifier and the second presentation identifier with different display effects, e.g., add an additional flag to the second presentation identifier.

In a possible implementation, to inform the game player which virtual player triggers the additional enhancement effect, the terminal may alternatively add a virtual player identifier to the second presentation identifier corresponding to the additional enhancement effect. In one embodiment, the virtual player identifier may be at least one of an avatar, an icon, a half-body portrait, a full-body portrait, or a presentation animation of the virtual player.

For example, as shown in FIG. 29, in a case that no virtual player triggers a second-round additional enhancement effect between the display of the second-round enhancement notification information and the display of the third-round enhancement notification information, the terminal displays, in a second-round enhancement effect display area 2901 of the effect application progress presentation interface and in response to the triggering operation of the game player on the application progress view control, only a presentation identifier corresponding to a second-round basic enhancement effect, including a presentation identifier 2902 corresponding to a second-round basic piece enhancement effect and a presentation identifier 2903 corresponding to a second-round basic player enhancement effect. After a virtual player triggers the second-round additional enhancement effect, the terminal additionally displays a presentation identifier 2904 corresponding to the second-round additional player enhancement effect in the second-round enhancement effect display area 2901.

In the foregoing embodiments, by setting the effect application progress presentation interface, the enhancement effects that have been prompted may be viewed at any time during the auto chess game. In addition, between the display of the i-th-round enhancement notification information and the display of the (i+1)-th-round enhancement notification information, the i-th-round enhancement effect in the effect application progress presentation interface is updated dynamically according to whether there is the i-th-round additional enhancement effect during the auto chess game. Thus, the convenience for a game player viewing an enhancement effect during a battle is improved, so that a battle strategy can be adjusted in time based on the enhancement effect.

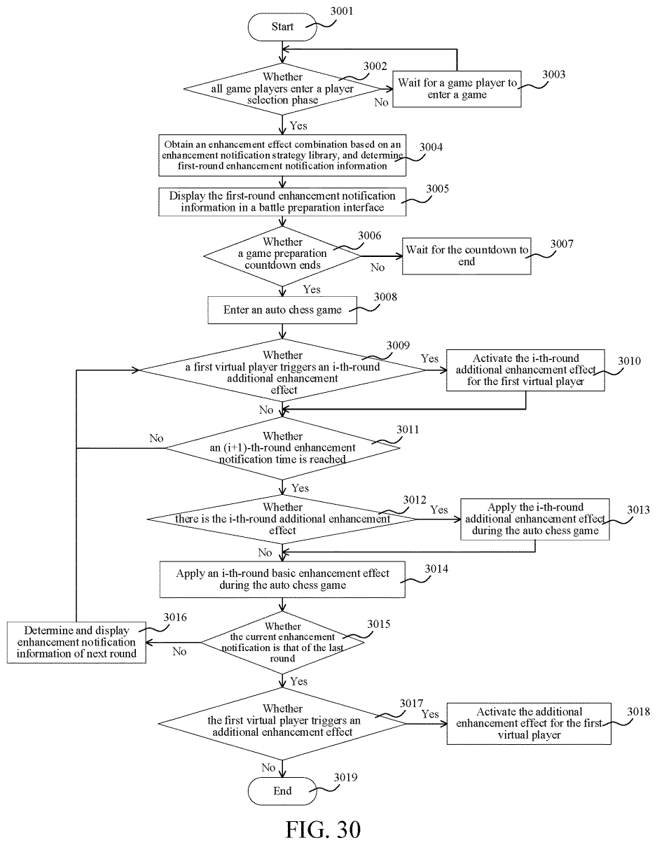

FIG. 30 illustrates a flowchart of a method for activating an enhancement effect in an auto chess game according to yet another embodiment of this disclosure.

Operation 3001: Start.

Operation 3002: Whether all game players enter a player selection phase?

First, after an auto chess game is started, a terminal needs to determine whether all game players enter the player selection phase and determine a virtual player selected and controlled by each game player and a player attribute corresponding to the virtual player.

Operation 3003: Wait for a game player to enter a battle.

In a case that a game player has not completed virtual player selection, the system continues to wait for the game player to enter the battle and perform player selection.

Operation 3004: Obtain an enhancement effect combination based on an enhancement notification strategy library, and determine first-round enhancement notification information.

After all game players complete virtual player selection, the terminal acquires, based on the virtual players in the auto chess game and the player attributes, random enhancement effects from the enhancement notification strategy library, determines the enhancement effect combination, and determines the first-round enhancement notification information.

In one embodiment, the terminal may determine enhancement notification configuration information corresponding to the auto chess game from the enhancement notification strategy library. The enhancement notification configuration information may include an information notification time of each round and enhancement notification information of each round. In one embodiment, the terminal may alternatively determine first-round enhancement notification information and an information notification time corresponding to an enhancement notification of each round from the enhancement notification strategy library, and then determine (i+1)-th-round enhancement notification information based on additional enhancement effects of the first i rounds and enhancement notification information of the first i rounds before displaying the (i+1)-th-round enhancement notification information.

Operation 3005: Display the first-round enhancement notification information in a battle preparation interface.

Further, the terminal first displays the first-round enhancement notification information in the battle preparation interface. The first-round enhancement notification information indicates a first-round basic enhancement effect applied to the auto chess game when a second-round enhancement notification information is displayed.

In one embodiment, the first-round basic enhancement effect may include a first-round basic player enhancement effect and a first-round basic piece enhancement effect.

Operation 3006: Whether a battle preparation countdown ends?

The terminal determines in real time whether the battle preparation countdown ends. In a case that the battle preparation countdown does not end, operation 3007 is performed to continue to wait for the countdown to end. In a case that the battle preparation countdown has ended, operation 3008 is performed.

Operation 3007: Wait for the countdown to end.

Operation 3008: Enter the auto chess game.

When the battle preparation countdown ends, the terminal controls each virtual player to enter the auto chess game, and at a battle preparation phase, the game player may select and configure a plurality of virtual pieces for the virtual player.

In one embodiment, the number of virtual pieces that can be configured for the virtual player may be related to the level of the virtual player, may be related to the number of virtual pieces that the virtual player already possesses, may be related to a turn round, or may be related to other battle factors.

Operation 3009: Whether a first virtual player triggers an i-th-round additional enhancement effect?

Between the executions of the i-th-round and (i+1)-th-round enhancement notifications, to increase the diversity of enhancement effect activation, the terminal may trigger an additional enhancement effect according to the game state of the virtual player or the virtual piece, and add the additional enhancement effect as a game player intervention effect to the i-th-round enhancement effect. Therefore, the terminal needs to determine in real time whether the first virtual player triggers the i-th-round additional enhancement effect during the auto chess game.

The first virtual player triggering the i-th-round additional enhancement effect includes not only that the first virtual player triggers an i-th-round additional player enhancement effect, but also that the first virtual piece configured for the first virtual player triggers an i-th-round additional piece enhancement effect.

In one embodiment, the first virtual player triggering the i-th-round additional player enhancement effect may be triggered by using an enhancement effect activation item, or may be triggered by casting an enhancement effect activation skill.

In one embodiment, the first virtual piece configured for the first virtual player triggering the i-th-round additional piece enhancement effect may be triggered by using a piece enhancement item, or may be triggered based on a piece configuration condition.

Operation 3010: Activate the i-th-round additional enhancement effect for the first virtual player.

In a case that the first virtual player triggers the i-th-round additional enhancement effect, the terminal activates the i-th-round additional enhancement effect for the first virtual player or the first virtual piece configured for the first virtual player.

In one embodiment, in a case that the first virtual player meets an activation condition for an additional player enhancement effect, the terminal activates the i-th-round additional player enhancement effect for the first virtual player, and may determine that the virtual player triggers the i-th-round additional enhancement effect during the auto chess game.

In one embodiment, in a case that the first virtual piece configured for the first virtual player meets an activation condition for an additional piece enhancement effect, the terminal activates the i-th-round additional piece enhancement effect for the first virtual piece, and may determine that the virtual player triggers the i-th-round additional enhancement effect during the auto chess game.

Operation 3011: Whether an (i+1)-th-round enhancement notification time is reached?

The terminal determines in real time whether the (i+1)-th-round enhancement notification time is reached. In a case that the (i+1)-th-round enhancement notification time is reached, operation 3012 is performed. In a case that the (i+1)-th-round enhancement notification time is not reached, operation 3009 is performed to continue to determine whether the first virtual player triggers the i-th-round additional enhancement effect.

Operation 3012: Whether there is the i-th-round additional enhancement effect?

When the (i+1)-th-round enhancement notification time is reached, the terminal first determines whether there is the i-th-round additional enhancement effect between the display of the i-th-round enhancement notification information and the display of the (i+1)-th-round enhancement notification information. In a case that there is no i-th-round additional enhancement effect, a further notification is only provided for the i-th-round basic enhancement effect. In a case that there is the i-th-round additional enhancement effect, the i-th-round additional enhancement effect is revealed.

Operation 3013: Apply the i-th-round additional enhancement effect during the auto chess game.

In a case that there is the i-th-round additional enhancement effect, the terminal applies the i-th-round additional enhancement effect to the auto chess game when displaying the (i+1)-th-round enhancement notification information. Further, in a case that a second virtual player meets an activation condition for the i-th-round additional enhancement effect, the terminal activates the i-th-round additional enhancement effect for the second virtual player.

Operation 3014: Apply the i-th-round basic enhancement effect during the auto chess game.

In a case that there is no i-th-round additional enhancement effect, the terminal applies only the i-th-round basic enhancement effect during the auto chess game when displaying the (i+1)-th-round enhancement notification information. Further, in a case that the second virtual player meets an activation condition for the i-th-round basic enhancement effect, the terminal activates the i-th-round basic enhancement effect for the second virtual player.

Operation 3015: Whether the current enhancement notification is that of the last round?

Moreover, when displaying the enhancement notification information of each round, the terminal needs to determine whether the enhancement notification of the current round is the enhancement notification of the last round. In a case that the current round is the last round of enhancement notification, operation 3017 is performed. In a case that the current round is not the last round of enhancement notification, operation 3016 is performed.

Operation 3016: Determine and display enhancement notification information of next round.

In a case that the current round of enhancement notification is not the last round of enhancement notification, the terminal continues to determine the enhancement notification information of next round, and displays the enhancement notification information of next round. Thus, operations 3009 to 3015 are performed circularly.

Operation 3017: Whether the first virtual player triggers an additional enhancement effect?

In a case that the current round of enhancement notification is the last round of enhancement notification, the terminal needs to determine whether the first virtual player triggers the additional enhancement effect during the subsequent auto chess game.

Operation 3018: Activate the additional enhancement effect for the first virtual player.

In a case that the first virtual player triggers the additional enhancement effect, the terminal only needs to activate the additional enhancement effect for the first player or the first virtual piece configured for the first virtual player, and does not need to apply the additional enhancement effect to the auto chess game.

### Operation 3019: End.

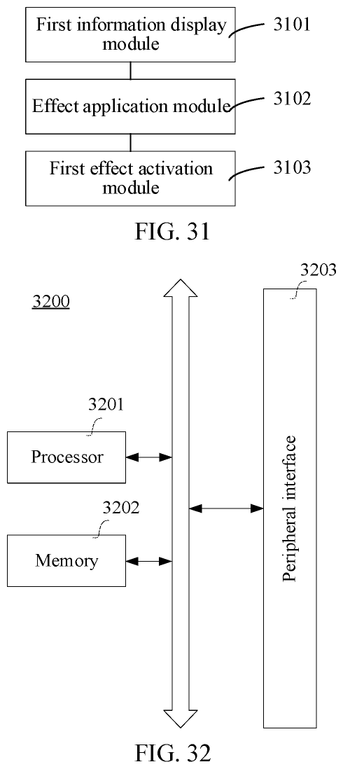

FIG. 31 illustrates a structural block diagram of an apparatus for activating an enhancement effect in an auto chess according to an embodiment of this disclosure. The apparatus includes:
a first information display module 3101 configured to display i-th-round enhancement notification information, the i-th-round enhancement notification information indicating an i-th-round basic enhancement effect applied during an auto chess game when an (i+1)-th-round enhancement notification information is displayed, and i being greater than or equal to 1 and being a positive integer;
an effect application module 3102 configured to apply an i-th-round enhancement effect during the auto chess game when (i+1)-th-round enhancement notification information is displayed, the i-th-round enhancement effect including the i-th-round basic enhancement effect; and
a first effect activation module 3103 configured to activate the i-th-round enhancement effect for a virtual character in a case that the virtual character meets an activation condition for the i-th-round enhancement effect, the virtual character including at least one of a virtual player or a virtual piece in the auto chess game.

In one embodiment, the effect application module 3102 includes:
a first effect application unit configured to apply the i-th-round basic enhancement effect and an i-th-round additional enhancement effect during the auto chess game when the (i+1)-th-round enhancement notification information is displayed, in a case that the virtual player triggers the i-th-round additional enhancement effect between the display of the i-th-round enhancement notification information and the display of the (i+1)-th-round enhancement notification information; and
a second effect application unit configured to apply the i-th-round basic enhancement effect during the auto chess game when the (i+1)-th-round enhancement notification information is displayed, in a case that the virtual player does not trigger the i-th-round additional enhancement effect between the display of the i-th-round enhancement notification information and the display of the (i+1)-th-round enhancement notification information.

In one embodiment, the apparatus further includes:
a second effect activation module configured to activate an i-th-round additional player enhancement effect for a first virtual player in a case that the first virtual player meets an activation condition for an additional player enhancement effect between the display of the i-th-round enhancement notification information and the display of the (i+1)-th-round enhancement notification information, and determine that the virtual player triggers the i-th-round additional enhancement effect during the auto chess game; or
a third effect activation module configured to activate the i-th-round additional piece enhancement effect for a first virtual piece in a case that the first virtual piece configured for the first virtual player meets an activation condition for an additional piece enhancement effect between the display of the i-th-round enhancement notification information and the display of the (i+1)-th-round enhancement notification information, and determine that the virtual player triggers the i-th-round additional enhancement effect during the auto chess game.

In one embodiment, the second effect activation module is configured to:
activate the i-th-round additional player enhancement effect for the first virtual player in a case that the first virtual player uses an enhancement effect activation item, the i-th-round additional player enhancement effect being a player enhancement effect corresponding to the enhancement effect activation item; or
activate the i-th-round additional player enhancement effect for the first virtual player in a case that the first virtual player casts an enhancement effect activation skill, the i-th-round additional player enhancement effect being a player enhancement effect corresponding to the enhancement effect activation skill.

In one embodiment, the third effect activation module is configured to:
activate the i-th-round additional piece enhancement effect for the first virtual piece in a case that the first virtual player uses a piece enhancement item for the first virtual piece, the i-th-round additional piece enhancement effect being a piece enhancement effect corresponding to the piece enhancement item; or
activate the i-th-round additional piece enhancement effect for the first virtual piece in a case that the first virtual piece configured for the first virtual player meets a piece configuration condition, the i-th-round additional piece enhancement effect being a piece enhancement effect triggered by the piece configuration condition, and the piece configuration condition being related to at least one of a piece configuration quantity or a piece configuration type.

In one embodiment, the first effect activation module 3103 includes:
a first effect activation unit configured to activate an i-th-round player enhancement effect for a second virtual player in a case that the i-th-round enhancement effect includes the i-th-round player enhancement effect and the second virtual player meets a first activation condition for the i-th-round player enhancement effect, the first activation condition being related to at least one of a level of a player, a virtual economic value obtained by the player, or a virtual piece possessed by the player; and
a second effect activation unit configured to activate an i-th-round piece enhancement effect for a second virtual piece in a case that the i-th-round enhancement effect includes the i-th-round piece enhancement effect and the second virtual piece configured for the second virtual player meets a second activation condition for the i-th-round piece enhancement effect, the second activation condition being related to at least one of a piece attribute, a piece quantity, a piece type, or an item configured for a piece.

In one embodiment, the second effect activation unit is configured to:
activate the i-th-round piece enhancement effect for the second virtual piece in a case that the i-th-round enhancement effect includes the i-th-round piece enhancement effect and a piece attribute of the second virtual piece meets a piece attribute condition, the i-th-round piece enhancement effect being configured for switching the second virtual piece from a first piece state to a second piece state, the second virtual piece in the first piece state possessing a basic skill, the second virtual piece in the second piece state possessing the basic skill and an additional skill, and virtual pieces of a same type in the second piece state being capable of simultaneously casting a same virtual skill; or
activate the i-th-round piece enhancement effect for the second virtual pieces of a same piece type in a case that the i-th-round enhancement effect includes the i-th-round piece enhancement effect and a number of the second virtual pieces of the same piece type reaches a piece quantity threshold.

In one embodiment, the first information display module 3101 is configured to:
display the i-th-round enhancement notification information in a case that an i-th-round information notification condition is met, the i-th-round information notification condition being related to at least one of an information notification time or a game state, and the i-th-round enhancement notification information indicating at least one of an i-th-round basic player enhancement effect or an i-th-round basic piece enhancement effect applied during the auto chess game when the (i+1)-th-round enhancement notification information is displayed.

In one embodiment, the apparatus further includes:
a first information determination module configured to determine enhancement notification configuration information corresponding to the auto chess game from an enhancement notification strategy library when the auto chess game is started, the enhancement notification configuration information including an information notification time of each round and an enhancement notification information of each round; or
a second information determination module configured to: determine first-round enhancement notification information and an information notification time corresponding to an enhancement notification of each round from the enhancement notification strategy library when the auto chess game is started; and determine the (i+1)-th-round enhancement notification information based on additional enhancement effects of the first i rounds and enhancement notification information of the first i rounds before the (i+1)-th-round enhancement notification information is displayed, the (i+1)-th-round enhancement notification information being different from the enhancement notification information of the first i rounds and not including the additional enhancement effects of the first i rounds.

In one embodiment,
the first-round enhancement notification information indicates a first-round basic enhancement effect applied during the auto chess game when a second-round enhancement notification information is displayed; and
the i-th-round enhancement notification information indicates the i-th-round basic enhancement effect applied during the auto chess game when the (i+1)-th-round enhancement notification information is displayed, and an (i−1)-th-round enhancement effect applied during the auto chess game at a current battle moment, i being greater than or equal to 2.

In one embodiment, the apparatus further includes:
a second information display module configured to display the (i+1)-th-round enhancement notification information in a case that the i-th-round basic enhancement effect in the i-th-round enhancement notification information is in an implicit notification state and an (i+1)-th-round information notification condition is met, the (i+1)-th-round enhancement notification information indicating the i-th-round basic enhancement effect in an explicit notification state.

In one embodiment, the apparatus further includes:
an interface display module configured to display an effect application progress presentation interface in response to a triggering operation on an application progress view control, the effect application progress presentation interface including the information notification time corresponding to the enhancement notification of each round, a player enhancement effect presentation area, and a piece enhancement effect presentation area, where piece enhancement effects are presented based on piece types in the piece enhancement effect presentation area; and a presentation identifier for an applied enhancement effect and a presentation identifier for an activated enhancement effect have different display effects in the effect application progress presentation interface.

In one embodiment, the interface display module is further configured to:
display a first presentation identifier corresponding to the i-th-round basic enhancement effect in the effect application progress presentation interface in response to the triggering operation on the application progress view control, in a case that the virtual player does not trigger the i-th-round additional enhancement effect, before the triggering operation on the application progress view control is received; and
display the first presentation identifier corresponding to the i-th-round basic enhancement effect and a second presentation identifier corresponding to the i-th-round additional enhancement effect in the effect application progress presentation interface in response to the triggering operation on the application progress view control, in a case that the virtual player triggers the i-th-round additional enhancement effect, before the triggering operation on the application progress view control is received, where the first presentation identifier and the second presentation identifier have different display effects.

Accordingly, in one or more embodiments of this disclosure, during the auto chess game, the i-th-round enhancement notification information is displayed, and a notification is provided in advance on the i-th-round basic enhancement effect applied during the auto chess game when the (i+1)-th-round enhancement notification information is displayed. Thus, the i-th-round enhancement effect is applied during the auto chess game when the (i+1)-th-round enhancement notification information is displayed. Besides, the i-th-round enhancement effect is activated for the virtual character in a case that the virtual character meets the activation condition for the i-th-round enhancement effect. To be specific, a notification will be provided in advance for the enhancement effect applied in each round when the enhancement notification of the previous round is provided. Thus, between the i-th-round and (i+1)-th-round enhancement notifications, a game player can properly adjust a battle strategy based on the i-th-round enhancement notification information, thereby improving the strategic depth of the auto chess game. Moreover, as long as a virtual character meets an activation condition for an enhancement effect, the enhancement effect can be applied to the virtual character. Thus, the fairness of enhancement effect activation during the auto chess game is enhanced.

The apparatus provided in the foregoing embodiments is described using the division of the foregoing functional modules as an example. In practice, the foregoing functions may be allocated to and completed by different functional modules as required. In other words, an internal structure of an apparatus is divided into different functional modules to complete some or all of the functions described above. In addition, the apparatus provided in the foregoing embodiments and the method embodiments belong to the same concept. Reference can be made to the method embodiments for further details of the implementation process, which will not be repeated here.

FIG. 32 illustrates a structural block diagram of a terminal 3200 provided by an embodiment of this disclosure. The terminal 3200 may be a portable mobile terminal, for example, a smartphone, a tablet computer, an MP3 player, or an MP4 player. The terminal 3200 may alternatively be referred to as another name such as a user equipment or a portable terminal.

In an example, the terminal 3200 includes processing circuitry (e.g., a processor 3201) and a memory 3202.

The processor 3201 may include one or more processing cores, such as a 4-core processor or an 8-core processor. The processor 3201 may be implemented by using any one of the following hardware forms: a digital signal processor (DSP), a field-programmable gate array (FPGA), or a programmable logic array (PLA). The processor 3201 may alternatively include a main processor and a coprocessor. The main processor is a processor configured to process data in an awake state, and is also referred to as a central processing unit (CPU). The coprocessor is a low power processor configured to process data in a standby state. In some embodiments, the processor 3201 may be integrated with a graphics processing unit (GPU). The GPU is configured to render and draw content that needs to be displayed on a display screen. In some embodiments, the processor 3201 may further include an artificial intelligence (AI) processor that is configured to process computing operations related to machine learning.

The memory 3202 may include one or more non-transitory computer-readable storage media. The memory 3202 may include a high-speed random access memory and a non-volatile memory, such as one or more disk storage devices or flash storage devices. In some embodiments, the non-transitory computer-readable storage medium in the memory 3202 is configured to store at least one instruction, the at least one instruction being configured to be executed by the processor 3201 to implement the method for activating an enhancement effect in an auto chess game provided in one or more embodiments of this disclosure.

In some embodiments, the terminal 3200 may alternatively include a peripheral interface 3203 and at least one peripheral device.

The peripheral interface 3203 may be configured to connect at least one peripheral device related to input/output (I/O) to the processor 3201 and the memory 3202. In some embodiments, the processor 3201, the memory 3202, and the peripheral interface 3203 are integrated on the same chip or circuit board. In some other embodiments, any one or two of the processor 3201, the memory 3202, and the peripheral interface 3203 may be implemented on an independent chip or circuit board. This is not limited in this disclosure.

A person skilled in the art may understand that the structure shown in FIG. 32 constitutes no limitation on the terminal 3200, and the terminal may include more or fewer components than those shown in the figure, or some components may be combined, or a different component arrangement may be used.

An embodiment of this disclosure further provides a non-transitory computer-readable storage medium. The non-transitory computer-readable storage medium has at least one program stored therein, and the at least one program is loaded and executed by processing circuitry (e.g., a processor) to implement the method for activating an enhancement effect in an auto chess game as described in one or more embodiments in this disclosure.

According to an aspect of this disclosure, provided is a computer program product, including computer instructions stored in a non-transitory computer-readable storage medium. Processing circuitry (e.g., a processor) of a terminal reads the computer instructions from the non-transitory computer-readable storage medium, and executes the computer instructions to cause the terminal to perform the method for activating an enhancement effect in an auto chess game according to one or more embodiments in this disclosure.

Modules, submodules, and units described herein may be implemented by processing circuitry, software instructions executed by one or more processors, or a combination of hardware and software. When implemented in software, the modules, submodules, and units are embodied as instructions stored in a non-transitory computer-readable storage medium and executed by one or more processors.

As used herein, “at least one of A, B, or C” is intended to include any one of A, B, or C, or any combination thereof. Similarly, “one of A and B” includes A, B, or both A and B.

A person skilled in the art is to be aware that in the foregoing one or more examples, the functions described in one or more embodiments of this disclosure may be implemented by hardware, software, firmware, or any combination thereof. When implemented by software, the functions may be stored in a non-transitory computer-readable storage medium or transmitted as one or more instructions or code on the non-transitory computer-readable storage medium. The storage medium may be any usable medium accessible by a general-purpose computer or a special-purpose computer.

The foregoing descriptions are non-limiting embodiments of this disclosure, but are not intended to limit this disclosure. Any modification, equivalent replacement, or improvement made within the spirit and principle of this disclosure shall fall within the scope of this disclosure.

What is claimed is:

1. A method for activating an enhancement effect in an auto chess game, the method comprising:
displaying i-th-round enhancement notification information, the i-th-round enhancement notification information indicating an i-th-round basic enhancement effect to be applied during the auto chess game, i being a positive integer;
applying one or more i-th-round enhancement effects during the auto chess game when (i+1)-th-round enhancement notification information is displayed, the one or more i-th-round enhancement effects including the i-th-round basic enhancement effect; and
activating one of the applied one or more i-th-round enhancement effects for a virtual character when the virtual character meets an activation condition of the one of the one or more i-th-round enhancement effects, the virtual character corresponding to a target virtual player or a target virtual piece in the auto chess game.

2. The method according to claim 1, wherein the applying the one or more i-th-round enhancement effects comprises:
applying the i-th-round basic enhancement effect and an i-th-round additional enhancement effect during the auto chess game when the (i+1)-th-round enhancement notification information is displayed, when a first virtual player triggers the i-th-round additional enhancement effect between display of the i-th-round enhancement notification information and display of the (i+1)-th-round enhancement notification information; and
applying the i-th-round basic enhancement effect during the auto chess game when the (i+1)-th-round enhancement notification information is displayed, when the first virtual player does not trigger the i-th-round additional enhancement effect between the display of the i-th-round enhancement notification information and the display of the (i+1)-th-round enhancement notification information.

3. The method according to claim 2, further comprising:
when the first virtual player meets an activation condition of an additional player enhancement effect between the display of the i-th-round enhancement notification information and the display of the (i+1)-th-round enhancement notification information, activating the additional player enhancement effect for the first virtual player and determining that the first virtual player triggers the additional player enhancement effect as the i-th-round additional enhancement effect; or
when a first virtual piece associated with the first virtual player meets an activation condition for an additional piece enhancement effect between the display of the i-th-round enhancement notification information and the display of the (i+1)-th-round enhancement notification information, activating the additional piece enhancement effect for the first virtual piece and determining that the first virtual player triggers the additional piece enhancement effect as the i-th-round additional enhancement effect.

4. The method according to claim 3, wherein the activation condition for the additional player enhancement effect comprises:
the first virtual player operating an enhancement effect activation item, the additional player enhancement effect corresponding to the enhancement effect activation item; or
the first virtual player casting an enhancement effect activation skill, the additional player enhancement effect corresponding to the enhancement effect activation skill.

5. The method according to claim 3, wherein the activation condition for the additional piece enhancement effect comprises:
the first virtual player operating a piece enhancement item for the first virtual piece, the additional piece enhancement effect corresponding to the piece enhancement item; or
the first virtual piece meeting a piece configuration condition corresponding to at least one of a piece configuration quantity or a piece configuration type.

6. The method according to claim 1, wherein the activating the one of the one or more applied i-th-round enhancement effects comprises:
activating an i-th-round player enhancement effect for a second virtual player when the one or more i-th-round enhancement effects include the i-th-round player enhancement effect and the second virtual player meets a first activation condition for the i-th-round player enhancement effect, the first activation condition being related to at least one of a level of a player, a virtual economic value obtained by the player, or a virtual piece possessed by the player; and
activating an i-th-round piece enhancement effect for a second virtual piece when the one or more i-th-round enhancement effects include the i-th-round piece enhancement effect and the second virtual piece associated with the second virtual player meets a second activation condition for the i-th-round piece enhancement effect, the second activation condition being related to at least one of a piece attribute, a piece quantity, a piece type, or an item configured for a piece.

7. The method according to claim 6, wherein
the second activation condition includes a piece attribute of the second virtual piece meeting a piece attribute condition, the i-th-round piece enhancement effect being configured to switch the second virtual piece from a first piece state to a second piece state, the second virtual piece in the first piece state possessing a basic skill, the second virtual piece in the second piece state possessing the basic skill and an additional skill, and virtual pieces of a same type in the second piece state being capable of simultaneously casting a same virtual skill.

8. The method according to claim 1, wherein the activating the one of the one or more applied i-th-round enhancement effects comprises:
activating the i-th-round piece enhancement effect for a plurality of virtual pieces of a same piece type when the one or more i-th-round enhancement effects include the i-th-round piece enhancement effect and a number of the plurality of virtual pieces of the same piece type reaches a piece quantity threshold.

9. The method according to claim 1, wherein the displaying the i-th-round enhancement notification information comprises:
displaying the i-th-round enhancement notification information when an i-th-round information notification condition is met, the i-th-round information notification condition being related to at least one of an information notification time and a game state, and the i-th-round basic enhancement effect indicated by the i-th-round enhancement notification information including at least one of an i-th-round basic player enhancement effect or an i-th-round basic piece enhancement effect.

10. The method according to claim 9, further comprising:
determining enhancement notification configuration information corresponding to the auto chess game from an enhancement notification strategy library when the auto chess game is started, the enhancement notification configuration information indicating an information notification time of each round and an enhancement notification information of each round; or
determining first-round enhancement notification information and an information notification time corresponding to an enhancement notification of each round from the enhancement notification strategy library when the auto chess game is started; and determining the (i+1)-th-round enhancement notification information based on additional enhancement effects of first i rounds and enhancement notification information of the first i rounds before the (i+1)-th-round enhancement notification information is displayed, the (i+1)-th-round enhancement notification information being different from the enhancement notification information of the first i rounds and not including the additional enhancement effects of the first i rounds.

11. The method according to claim 1, wherein
first-round enhancement notification information indicates a first-round basic enhancement effect applied during the auto chess game when a second-round enhancement notification information is displayed; and
the i-th-round enhancement notification information indicates the i-th-round basic enhancement effect applied during the auto chess game when the (i+1)-th-round enhancement notification information is displayed, and an (i−1)-th-round enhancement effect applied during the auto chess game at a current game moment between display of the i-th-round enhancement notification information and display of the (i+1)-th-round enhancement notification information.

12. The method according to claim 11, further comprising:
displaying the (i+1)-th-round enhancement notification information when the i-th-round basic enhancement effect indicated in the i-th-round enhancement notification information is in an implicit notification state and an (i+1)-th-round information notification condition is met, the (i+1)-th-round enhancement notification information indicating the i-th-round basic enhancement effect in an explicit notification state.

13. The method according to claim 1, further comprising:
displaying an effect application progress presentation interface when a triggering operation is performed on an application progress view control element, the effect application progress presentation interface including information notification time corresponding to display of enhancement notification information of each round, a player enhancement effect presentation area, and a piece enhancement effect presentation area, wherein
piece enhancement effects are presented based on piece types in the piece enhancement effect presentation area; and
a presentation identifier for an applied enhancement effect and a presentation identifier for an activated enhancement effect have different display effects in the effect application progress presentation interface.

14. The method according to claim 13, wherein the displaying the effect application progress presentation interface comprises:
displaying a first presentation identifier corresponding to the i-th-round basic enhancement effect in the effect application progress presentation interface when the triggering operation is performed on the application progress view control element, and when the virtual player does not trigger an i-th-round additional enhancement effect; and
displaying the first presentation identifier corresponding to the i-th-round basic enhancement effect and a second presentation identifier corresponding to the i-th-round additional enhancement effect in the effect application progress presentation interface when the triggering operation is performed on the application progress view control element, and when the virtual player triggers the i-th-round additional enhancement effect,
wherein the first presentation identifier and the second presentation identifier have different display effects.

15. An apparatus, comprising:
processing circuitry configured to:
display i-th-round enhancement notification information, the i-th-round enhancement notification information indicating an i-th-round basic enhancement effect to be applied during an auto chess game, i being a positive integer;
apply one or more i-th-round enhancement effects during the auto chess game when (i+1)-th-round enhancement notification information is displayed, the one or more i-th-round enhancement effects including the i-th-round basic enhancement effect; and
activate one of the applied one or more i-th-round enhancement effects for a virtual character when the virtual character meets an activation condition of the one of the one or more i-th-round enhancement effects, the virtual character corresponding to a target virtual player or a target virtual piece in the auto chess game.

16. The apparatus according to claim 15, wherein the processing circuitry is configured to:
apply the i-th-round basic enhancement effect and an i-th-round additional enhancement effect during the auto chess game when the (i+1)-th-round enhancement notification information is displayed, when a first virtual player triggers the i-th-round additional enhancement effect between display of the i-th-round enhancement notification information and display of the (i+1)-th-round enhancement notification information; and
apply the i-th-round basic enhancement effect during the auto chess game when the (i+1)-th-round enhancement notification information is displayed, when the first virtual player does not trigger the i-th-round additional enhancement effect between the display of the i-th-round enhancement notification information and the display of the (i+1)-th-round enhancement notification information.

17. The apparatus according to claim 16, wherein the processing circuitry is configured to:
when the first virtual player meets an activation condition of an additional player enhancement effect between the display of the i-th-round enhancement notification information and the display of the (i+1)-th-round enhancement notification information, activate the additional player enhancement effect for the first virtual player and determine that the first virtual player triggers the additional player enhancement effect as the i-th-round additional enhancement effect; or
when a first virtual piece associated with the first virtual player meets an activation condition for an additional piece enhancement effect between the display of the i-th-round enhancement notification information and the display of the (i+1)-th-round enhancement notification information, activate the additional piece enhancement effect for the first virtual piece and determine that the first virtual player triggers the additional piece enhancement effect as the i-th-round additional enhancement effect.

18. The apparatus according to claim 17, wherein the activation condition for the additional piece enhancement effect comprises:
the first virtual player operating a piece enhancement item for the first virtual piece, the additional piece enhancement effect corresponding to the piece enhancement item; or
the first virtual piece meeting a piece configuration condition corresponding to at least one of a piece configuration quantity or a piece configuration type.

19. The apparatus according to claim 15, wherein the processing circuitry is configured to:
activate an i-th-round player enhancement effect for a second virtual player when the one or more i-th-round enhancement effects include the i-th-round player enhancement effect and the second virtual player meets a first activation condition for the i-th-round player enhancement effect, the first activation condition being related to at least one of a level of a player, a virtual economic value obtained by the player, or a virtual piece possessed by the player; and
activate an i-th-round piece enhancement effect for a second virtual piece when the one or more i-th-round enhancement effects include the i-th-round piece enhancement effect and the second virtual piece associated with the second virtual player meets a second activation condition for the i-th-round piece enhancement effect, the second activation condition being related to at least one of a piece attribute, a piece quantity, a piece type, or an item configured for a piece.

20. A non-transitory computer-readable storage medium storing instructions, which when executed by a processor, cause the processor to perform a method for activating an enhancement effect in an auto chess game, the method comprising:
displaying i-th-round enhancement notification information, the i-th-round enhancement notification information indicating an i-th-round basic enhancement effect to be applied during the auto chess game, i being a positive integer;
applying one or more i-th-round enhancement effects during the auto chess game when (i+1)-th-round enhancement notification information is displayed, the one or more i-th-round enhancement effects including the i-th-round basic enhancement effect; and
activating one of the applied one or more i-th-round enhancement effects for a virtual character when the virtual character meets an activation condition of the one of the one or more i-th-round enhancement effects, the virtual character corresponding to a target virtual player or a target virtual piece in the auto chess game.
